(19) United States
(12) Patent Application Publication
(10) Pub. No.: US 2025/0297056 A1
(43) Pub. Date: Sep. 25, 2025

(54) METHOD FOR PRODUCING POLYETHERKETONEKETONE

(71) Applicant: ARKEMA FRANCE, Colombes (FR)

(72) Inventors: Julien JOUANNEAU, Pierre Benite Cedex (FR); Guillaume LE, Serquigny (FR); Salomé GRAVELAT, Serquigny (FR); Guillaume VINCENT, Serquigny (FR); Richard AUDRY, Colombes Cedex (FR)

(73) Assignee: ARKEMA FRANCE, Colombes (FR)

(21) Appl. No.: 18/862,853

(22) PCT Filed: May 5, 2023
(86) PCT No.: PCT/EP2023/062007

§ 371 Date: Nov. 4, 2024

(30) Foreign Application Priority Data
May 5, 2022 (FR) FR2204287

(51) Int. Cl. C08G 61/12

(52) U.S. Cl. CPC C08G 61/127; C08G 2261/122; C08G 2261/124; C08G 2261/312; C08G 2261/316; C08G 2261/41

(57) ABSTRACT

A process for manufacturing a polyether ketone ketone, involving: placing an aromatic ether or a mixture of aromatic ethers, including at least 50 mol % of 1,3-bis(4-phenoxybenzoyl)benzene, 1,4-bis(4-phenoxybenzoyl)benzene or a mixture thereof, relative to the total number of moles of aromatic ether(s), in contact with an acyl chloride or a mixture of acyl chlorides, and a Lewis acid, in all or part of a reaction solvent, so as to form a reaction mixture, the 1,3-bis(4-phenoxybenzoyl)benzene and/or 1,4-bis(4-phenoxybenzoyl)benzene essentially not being dissolved in the reaction solvent at the end of the step of placing in contact; and, polymerizing the reaction mixture, the polymerization being performed, at least in part, at a temperature Tp greater than or equal to 50° C.; the process including a step of gradual heating of the reaction mixture until acceleration of the polymerization reaction is achieved.

### TECHNICAL FIELD

The invention relates to the field of polyether ketone ketones.

More particularly, the invention relates to a process for manufacturing polyether ketone ketone by electrophilic precipitating polymerization.

The invention also relates to the polymer that may be obtained via this process.

### PRIOR ART

A process is known, notably from U.S. Pat. No. 3,791,890, for the electrophilic manufacture of polyether ether ketone from a mixture of isophthaloyl chloride and terephthaloyl chloride (acyl chlorides), reacted with diphenyl ether (aromatic ether) in the presence of aluminum chloride (Lewis acid) and using ortho-dichlorobenzene as reaction solvent.

Example 3 of U.S. Pat. No. 3,791,890 describes the preparation of a premix comprising acyl chlorides, diphenyl ether and aluminum chloride in a small amount of ortho-dichlorobenzene (350 mL) at a temperature of about −5° C. The reaction is then initiated by dispersing this premix in a large amount of ortho-dichlorobenzene (1250 mL) preheated to 100° C.

This sequence of first preparing a cold premix and then dispersing the premix in preheated reaction solvent allows the reaction mixture to be brought up to temperature extremely rapidly. Although the mechanisms taking place in the reaction medium are not fully understood, U.S. Pat. No. 3,791,890 indicates that this enables the polymer particles being formed to be separated, facilitates the polymerization reaction, and prevents the coagulation of the particles into a gelatinous mass characteristic of this polymerization reaction.

It is also known, notably from Example 3 of U.S. Pat. No. 4,816,556, that the sequence of preparing a cold premix and then dispersing it in preheated reaction solvent may also be performed in an alternative electrophilic process for manufacturing polyether ether ketone, in which 1,4-bis(4-phenoxybenzoyl)benzene (aromatic ether) is reacted with an acyl chloride, in the presence of aluminum chloride, using ortho-dichlorobenzene as reaction solvent.

Also, Example 3 of U.S. Pat. No. 4,816,556 includes the use of benzoyl chloride for controlling the molecular weight of the polymer obtained.

In practice, the processes of the above two patent documents have not proven to be totally effective, and only partially prevent the deposition of a gelatinous mass during polymerization on the reactor walls and the stirring system, entailing several drawbacks.

Firstly, this reduces the yield of the process, since this gel is difficult to recover. Secondly, it makes control of the polymerization reaction more complicated, since it may lead to a drift in the stoichiometry of the reagents. Thirdly, fouling of the walls reduces the heat transfer efficiency between the reactor's temperature control means and the reaction medium, making temperature control within the reactor more complicated. Fourthly, it necessitates the often laborious task of cleaning the reactor, which reduces the facility's productivity while at the same time generating liquid and solid effluents to be recycled and/or destroyed.

In addition, the sudden rise in temperature of the reaction medium implies poor control, at least temporarily, of the latter, which makes good repeatability of the process difficult.

Furthermore, as demonstrated in the experimental section of the present patent application, the polymer obtained via the processes according to the above two patent documents is in the form of large particles of fairly heterogeneous sizes, which notably makes the purification steps more complicated to perform.

Finally, as demonstrated in the experimental section of the present patent application, the process according to the above two patent documents does not allow good integration of the chain-limiting agent into the end of polymer chains for a given polymer viscosity.

It is also known practice, notably from WO 9 523 821, to add a polymer dispersant, enabling coagulation of a tacky polymer product to be avoided.

Said document explains that the tacky polymer product is in fact due to the complex formed by a low molecular weight polymer with the Lewis acid formed at the start of the polymerization reaction and which precipitates in the form of a gel that coats the walls of the reactor and the stirrer.

Among the dispersants, the patent denotes, for example, compounds having as side group a fragment having the formula:

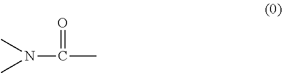

It is also known practice, notably from US 2012/0263953, to use control agents acting as dispersants, and notably to use benzoic acid and derivatives thereof.

However, the addition of a dispersant has a number of drawbacks. The use of certain dispersants, notably those with a fragment of formula (0) as illustrated above, leads to over-consumption of Lewis acid in the process, said acid also forming a complex with the dispersant. In addition, this complicates the management of the process effluents, notably the exploitation/recycling of the effluent containing the Lewis acid. Finally, the dispersant cannot be completely removed from the manufactured polymer and may have a detrimental effect on the thermal stability of the polymer.

Finally, still with the aim of avoiding coagulation and reactor fouling, EP 3 712 193 proposes a process in which an inert gas, notably nitrogen, is blown into the reaction medium during the polymerization reaction. Doing so may in certain cases be detrimental to fine temperature control in the reaction medium, and thus to good repeatability of the process.

Thus, there is currently a need to improve the process for manufacturing polyether ketone ketone in order to further limit fouling caused by, according to current knowledge, oligomer-Lewis acid complex coagulation. There is also a need to provide a manufacturing process that is simpler and/or that has good repeatability and/or that has a better yield and/or that is more efficient.

The present invention proposes such a process which preferentially overcomes one or more drawbacks of the processes according to the prior art, and also polymers that may be obtained via this process.

### OBJECTS OF THE INVENTION

One object of the invention is, at least according to certain embodiments, to propose a process which is simple to perform, and which effectively limits fouling of the polymerization reactor.

Another object of the invention is, at least according to certain embodiments, to increase the yield of the process for manufacturing polyether ketone ketone.

Another object of the invention is, at least according to certain embodiments, to increase the efficacy of the process for manufacturing polyether ketone ketone, notably enabling less frequent cleaning of the reactor.

Another object of the invention is, at least according to certain embodiments, to propose a process enabling optimum control of the reaction parameters, notably the temperature inside the reactor.

Another object of the invention is, at least according to certain embodiments, to propose a process enabling optimum control of the degree of polymerization, which is measured indirectly but in the usual manner by evaluating the viscosity of the polymer manufactured.

Another object of the invention is, at least according to certain embodiments, to propose a process enabling optimum control of the chain-end chemistry of the manufactured polymer.

Another object of the invention is, at least according to certain embodiments, to obtain polymer particles of more homogeneous size and/or smaller size.

### SUMMARY OF THE INVENTION

The invention relates to a process for manufacturing a polyether ketone ketone, which involves:
placing an aromatic ether or a mixture of aromatic ethers, comprising at least 50 mol % of 1,3-bis(4-phenoxybenzoyl)benzene, 1,4-bis(4-phenoxybenzoyl)benzene or a mixture thereof, relative to the total number of moles of aromatic ether(s), in contact with an acyl chloride or a mixture of acyl chlorides, and a Lewis acid, in all or part of a reaction solvent, so as to form a reaction mixture. The 1,3-bis(4-phenoxybenzoyl)benzene and/or 1,4-bis(4-phenoxybenzoyl)benzene are essentially not dissolved in the reaction solvent at the end of the step of placing in contact; and,
polymerizing the reaction mixture, the polymerization being performed, at least in part, at a temperature Tp greater than or equal to 50° C.

The process is characterized in that it comprises a step of gradual heating of the reaction mixture until acceleration of the polymerization reaction is achieved, the gradual heating step being performed at an average heating rate chosen in a range from 0.65° C./minute to 2.5° C./minute.

Among the chemical species introduced during the process, notably during the step of placing in contact and/or during polymerization, and/or during the gradual heating step, one or more chain-limiting agents may optionally be added.

According to certain embodiments, the acyl chloride(s) are chosen from the group consisting of: terephthaloyl chloride, isophthaloyl chloride, phthaloyl chloride, phosgene, adipoyl dichloride, tetrabromophthaloyl chloride, and compounds having the chemical formula:

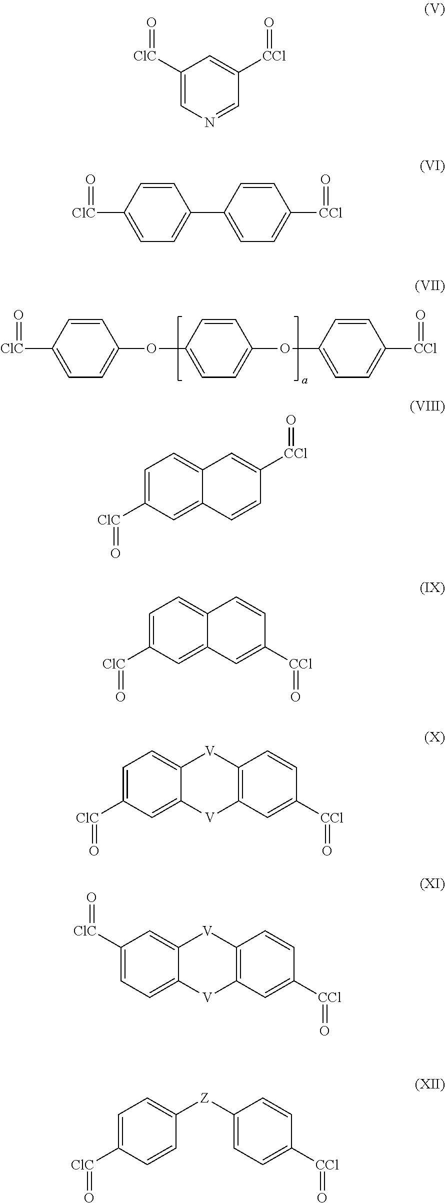

in which:
a is an integer ranging from 0 to 3;
V is chosen from: —O—, —S—, —(CF₂)_{q}—, —(CH₂)_{q}—, or —C((CH₃)₂)—;
Z is chosen from: —C(O)—, —SO₂—, —C(O)—C₆H₄—C(O)—, —O—(CF₂)_{q}—O—, —S—, —(CF₂)_{q}—, —(CH₂)_{q}—, or C—(CH₃)₂—; and in which q is an integer ranging from 1 to 20.

According to certain embodiments, a mixture of aromatic ethers is used. This mixture comprises, in addition to an aromatic ether chosen from the group consisting of: 1,3-bis(4-phenoxybenzoyl)benzene, 1,4-bis(4-phenoxybenzoyl)benzene, or a mixture thereof, at least one other aromatic ether chosen from the group consisting of:
diphenyl ether, 4,4′-diphenoxybenzophenone, 3,3′-diphenoxybenzophenone, 3,4′-diphenoxybenzophenone,
the products of reaction by electrophilic Friedel-Crafts substitution of two molecules, notably the same two molecules, chosen from: diphenyl ether, 4,4′-diphenoxybenzophenone, 3,3′-diphenoxybenzophenone, 3,4′-diphenoxybenzophenone with an acyl chloride molecule chosen from: phthaloyl chloride, phosgene, adipoyl dichloride, and the compounds having the chemical formula:

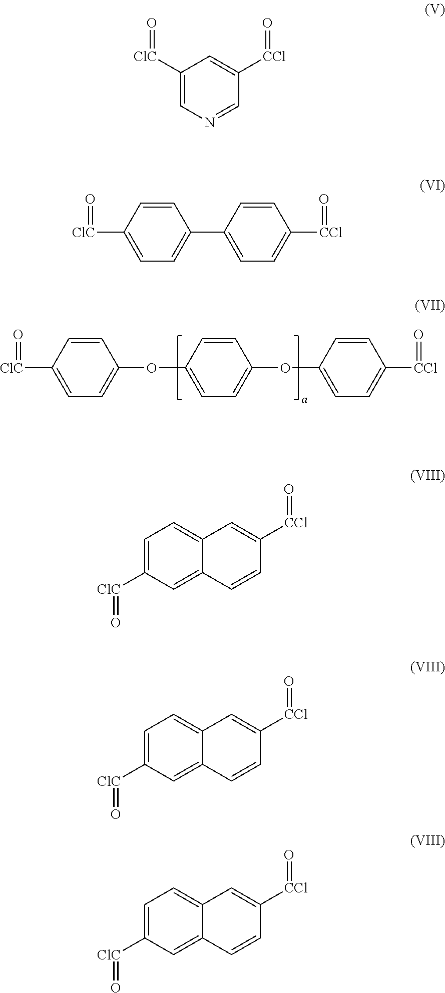

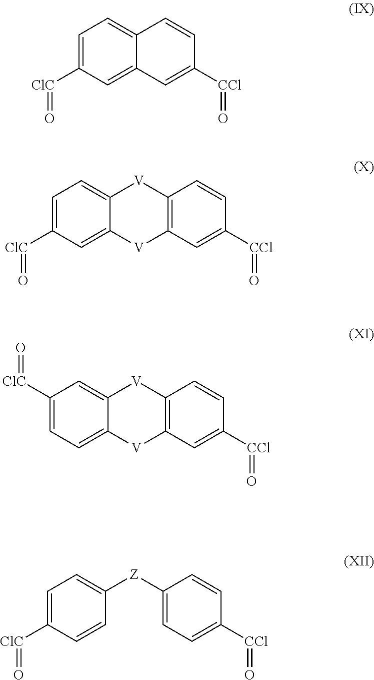

in which:
a is an integer ranging from 0 to 3;
V is chosen from: —O—, —S—, —(CF₂)_{q}—, —(CH₂)_{q}—, or —C((CH₃)₂)—;
Z is chosen from: —C(O)—, —SO₂—, —C(O)—C₆H₄—C(O)—, —O—(CF₂)_{q}—O—, —S—, —(CF₂)_{q}—, —(CH₂)_{q}—, or C—(CH₃)₂—; and in which q is an integer ranging from 1 to 20;
and the products of the electrophilic Friedel-Crafts substitution reaction of two molecules, notably the same two molecules, chosen from: 4,4′-diphenoxybenzophenone, 3,3′-diphenoxybenzophenone, and 3,4′-diphenoxybenzophenone with an acyl chloride molecule chosen from: terephthaloyl chloride and isophthaloyl chloride.

According to certain embodiments, the reaction solvent is chosen from the group consisting of: ortho-dichlorobenzene, 1,2,4-trichlorobenzene, 1,2,3-trichlorobenzene, ortho-difluorobenzene, and mixtures thereof.

According to certain embodiments, the Lewis acid is chosen from the group consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof.

According to certain embodiments, at least one chain-limiting agent is added during the process.

The chain-limiting agent may be a nucleophilic chain-limiting agent. Said agent is preferentially chosen from the compounds having the following chemical formula:

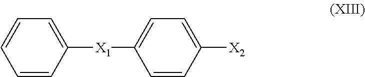

in which:
X₁ represents a covalent bond, —O— or —S—; and
X₂ represents C₆H₅CO or C₆H₅SO₂; and

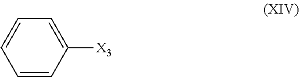

in which:
X₃ represents a halogen atom, an alkyl group or an alkoxy group containing from 1 to 10 carbon atoms.

Alternatively, or in addition, the chain-limiting agent may be an electrophilic chain-limiting agent. Said agent is preferentially chosen from the compounds having the following formula:

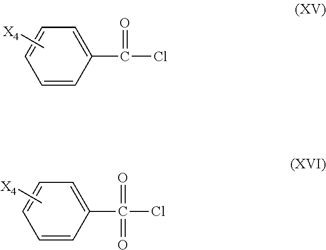

in which:
X₄ represents a hydrogen atom, a halogen atom, an alkyl or alkoxy group containing from 1 to 10 carbon atoms, or a nitro, C₆H₅CO or C₆H₅SO₂ group;
or of the formula:

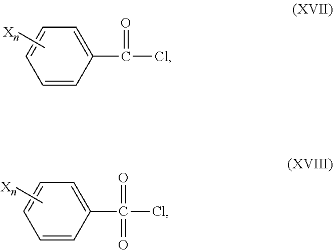

in which:
Xn represents n groups, n being an integer chosen between 2 and 5, each group being independently chosen from: a halogen atom, an alkyl or alkoxy group containing from 1 to 10 carbon atoms, or a nitro, C₆H₅CO or C₆H₅SO₂ group.

According to certain embodiments, the mole ratio of aromatic ether(s) relative to the reaction solvent(s) that have been introduced in total into the reaction mixture at the end of the polymerization is: from 0.005 to 0.030, preferentially: from 0.008 to 0.025 and very preferably: from 0.010 to 0.022.

According to certain embodiments, an excess of aromatic ether(s) is reacted with the acyl chloride(s). Advantageously, the mole ratio of aromatic ether(s) relative to the acyl chloride(s) that have been introduced in total into the reaction mixture at the end of the step of placing in contact is preferentially from 1.001 to 1.1.

According to certain embodiments, the mole ratio of Lewis acid(s) relative to the aromatic ether(s) that have been introduced in total into the reaction mixture at the end of the step of placing in contact is from 5.0 to 7.0, preferentially from 5.5 to 6.5.

According to certain embodiments, the reaction mixture is maintained during the step of placing in contact at a temperature T₀ of less than or equal to 5° C., preferentially less than or equal to 0° C., and more preferably less than or equal to −5° C.

According to certain embodiments, the temperature Tp is less than or equal to 120° C., and preferentially less than or equal to 100° C.

According to certain embodiments, the gradual heating step and the polymerization are performed with stirring, preferentially using a stirring means comprising at least one dual flow rotor.

According to certain embodiments, a mixture of aromatic ethers is used to perform the process. This mixture of aromatic ethers is formed from an aromatic ether chosen from: 1,4-bis(4-phenoxybenzoyl)benzene, 1,3-bis(4-phenoxybenzoyl)benzene or a mixture thereof; and another aromatic ether chosen from: diphenyl ether, 4,4′-diphenoxybenzophenone, or a mixture thereof. The mixture of aromatic ethers comprises up to 20 mol %, preferentially up to 10 mol % and more preferably up to 5 mol % of said other aromatic ether, relative to the total number of moles of aromatic ethers.

According to certain embodiments, the aromatic ether or, where appropriate, the mixture of aromatic ethers, consists of or, respectively, consists essentially of 1,4-bis(4-phenoxybenzoyl)benzene.

According to certain embodiments, the acyl chloride(s) are chosen from the group consisting of isophthaloyl chloride, terephthaloyl chloride, and a mixture thereof.

According to certain embodiments, the Lewis acid is aluminum trichloride.

According to certain embodiments, the reaction solvent is ortho-dichlorobenzene.

According to certain embodiments, a chain-limiting agent is added during the process. This chain-limiting agent may be benzoyl chloride, p-fluorobenzoyl chloride, 3,5-difluorobenzoyl chloride, or a mixture thereof. This chain-limiting agent may notably be benzoyl chloride, p-fluorobenzoyl chloride, or a mixture thereof.

According to certain embodiments, the gradual heating step is performed at an average heating rate ranging from 0.70° C./min to 2.2° C./min, preferentially at an average heating rate ranging from 0.75° C./min to 2.0° C./min, and more preferably at an average heating rate ranging from 0.8° C./min to 1.8° C./min.

According to certain embodiments, a mass fraction of reaction solvent at least equal to 0.15 is introduced before the end of the step of placing in contact, the mass fraction being calculated by dividing the weight of reaction solvent which has been introduced at the end of the step of placing in contact by the total weight of reaction solvent which has been introduced at the end of the polymerization.

The present invention also relates to a polyether ketone ketone having chain ends controlled by a chain limiter, satisfying the following inequality:

IV*FDC_{(LDC)}≥LIM; (eq.1)
in which:
IV represents the inherent viscosity of the polymer, expressed in dl/g, as measured according to the standard ISO 307-2009 applied to PEKK;
FDC_{(LDC)} represents the molar concentration of the group originating from the chain limiter relative to the total weight of the polymer, expressed in micro-equivalents of chain limiter per gram of polymer;
LIM is a number at least equal to 40.

This polymer is capable of being obtained via an electrophilic process, notably via the electrophilic process according to the invention.

According to certain embodiments, the chain-limiting agent is a nucleophilic chain-limiting agent chosen from the compounds having the following chemical formula:

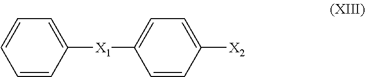

in which:
X₁ represents: a covalent bond, —O—, or —S—; and
X₂ represents C₆H₅CO or C₆H₅SO₂; and

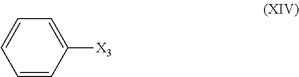

in which:
X₃ represents a halogen atom, an alkyl group or an alkoxy group containing from 1 to 10 carbon atoms;
or, the chain-limiting agent is an electrophilic chain-limiting agent chosen from the compounds having the following formulae:

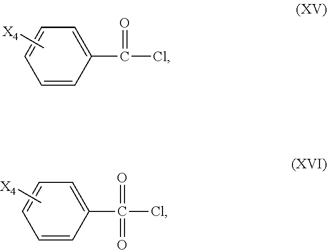

in which:
X₄ represents a hydrogen atom, a halogen atom, an alkyl or alkoxy group containing from 1 to 10 carbon atoms, or a nitro, C₆H₅CO or C₆H₅SO₂ group;
and

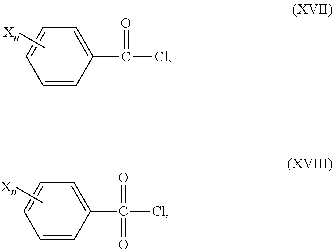

in which:
Xn represents n groups, n being an integer chosen between 2 and 5, each group being independently chosen from: a halogen atom, an alkyl or alkoxy group containing from 1 to 10 carbon atoms, or a nitro, C₆H₅CO or C₆H₅SO₂ group.

According to certain embodiments, the chain-limiting agent is benzoyl chloride, p-fluorobenzoyl chloride, 3,5-difluorobenzoyl chloride, or a mixture thereof.

According to certain embodiments, the chain-limiting agent is benzoyl chloride, p-fluorobenzoyl chloride, or a mixture thereof.

According to certain embodiments, the polyether ketone ketone has an inherent viscosity greater than or equal to 0.4 dl/g, preferentially greater than or equal to 0.5 dl/g, preferentially greater than or equal to 0.6 dl/g and more preferably greater than or equal to 0.7 dl/g, the inherent viscosity being measured at a concentration of 0.0005 g/mL in a 96.00% sulfuric acid solution at 25° C. using a viscometer such as an Ubbelohde suspended-level viscometer according to the standard ISO 307-2009.

Alternatively, or in addition, the polyether ketone ketone has an inherent viscosity of less than or equal to 2 dl/g, and preferentially less than or equal to 1.5 dl/g.

According to certain embodiments, the polyether ketone ketone has an inherent viscosity ranging from 0.98 dl/g, to 1.4 dl/g.

According to certain embodiments, the polyether ketone ketone does not comprise any dispersant.

According to certain embodiments, the polyether ketone ketone according to the invention is in the form of a powder characterized in that the mass proportion of particles with a size strictly greater than 630 micrometers is less than or equal to 25%, preferentially less than or equal to 15%, and more preferentially less than or equal to 10%, as obtained by screening using a sieve with a mesh size equal to 630 micrometers.

According to certain embodiments, the polyether ketone ketone according to the invention is in the form of a powder characterized in that the mass proportion of particles with a size strictly greater than 450 micrometers is less than or equal to 75%, preferentially less than or equal to 50%, more preferentially less than or equal to 25%, even more preferentially less than or equal to 20%, and most preferably less than or equal to 16%, as obtained by screening using a sieve with a mesh size equal to 450 micrometers.

According to certain embodiments, the polyether ketone ketone powder has a tapped density, as measured in the examples, of greater than or equal to 200 kg/m³.

According to certain embodiments, the polyether ketone ketone powder has a BET specific surface area less than or equal to 4 m²/g.

### DETAILED DESCRIPTION OF THE INVENTION

The polyether ketone ketones, also known as PEKKs, prepared according to the process of the invention comprise at least 25 mol %, relative to the total number of moles of polymer repeating units, of a repeating unit chosen from the group consisting of:

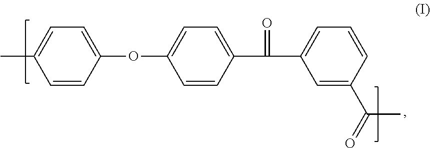

also denoted as the isophthalic unit or by the initial “I”;

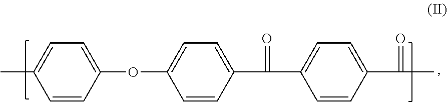

also denoted as the terephthalic unit or by the initial “T”; and,
a mixture thereof.

The polyether ketone ketones manufactured according to the invention may comprise at least 30 mol %, or at least 40 mol %, or at least 50 mol %, or at least 60 mol %, or at least 70 mol %, or at least 80 mol %, or at least 90 mol %, or 100% of the repeating units of formula (I) and/or formula (II) relative to the total number of moles of the repeating units of the polymer.

According to the embodiments in which the polyether ketone ketone comprises repeating units of formula (I) and formula (II), these units are considered as a whole relative to the total number of moles of repeating units in the polymer.

According to certain embodiments, the polyether ketone ketones according to the invention consist essentially of, i.e. comprise, at least 95 mol %, preferentially at least 98 mol %, of the repeating units of formula (I) and/or of formula (II), where appropriate considered as a whole, relative to the total number of moles of the repeating units of the polymer.

According to certain embodiments, the polyether ketone ketones according to the invention consist essentially of, or consist of, repeating units of formula (I) and/or of formula (II), the proportion of units of formula (II) relative to the units of formula (I), noted as the ratio T:I, being from 50:50 to 100:0. The ratio T:I may notably be from 50:50 to 55:45, or from 55:45 to 65:35, or from 65:35 to 75:25, or from 75:25 to 85:15, or from 85:15 to 95:5, 95:5 to 100:0.

According to certain embodiments, the polyether ketone ketones consist of repeating units of formula (I) and of formula (II), the proportion of units of formula (II) relative to the units of formula (I), noted as the ratio T:I, being from 55:45 to 95:5.

According to certain embodiments, the polyether ketone ketones according to the invention consist essentially of, or consist of, repeating units (1) and/or (II), with a ratio T:I of from 0:100 to 50:50. Notably the ratio T:I may be from 0:100 to 5:95, or from 5:95 to 10:90, or from 10:90 to 20:80, or from 20:80 to 30:70, or from 30:70 to 40:60, or from 40:60 to 50:50.

The polymerization reaction involved is a polycondensation reaction involving electrophilic substitution between one or more aromatic ethers with one or more acyl chlorides, in the presence of a Lewis acid and optionally a chain-limiting agent in a reaction solvent. The polymerization reaction is also precipitating due to the fact that the polymer formed precipitates from the reaction mixture. Finally, it is exothermic. Hydrogen chloride is produced during the polycondensation.

Without being bound by theory, the inventors believe that performing the process according to the invention, notably placing the reagents in contact so as to form a reaction mixture in which the 1,3-bis(4-phenoxybenzoyl)benzene and/or 1,4-bis(4-phenoxybenzoyl)benzene remain essentially in suspension, followed by a gradual heating step, allows a metastable state of the reaction mixture to be created in which the 1,3-bis(4-phenoxybenzoyl)benzene and/or the 1,4-bis(4-phenoxybenzoyl)benzene are essentially in suspension. Keeping the 1,3-bis(4-phenoxybenzoyl)benzene and/or 1,4-bis(4-phenoxybenzoyl)benzene, where appropriate considered as a whole, in insoluble form in the reaction mixture for a sufficiently long time enables the acceleration of the polymerization reaction to take place at a higher temperature than under conditions where a thermodynamic equilibrium would be allowed to become established. Doing so allows the polymerization reaction to be initiated with rapid kinetics and thus limits the time during which the reaction mixture is essentially formed of low-molecular-weight polymer chains, these polymer chains being particularly liable to coagulate and to form a gel fouling the reactor walls and/or the stirring system. The process according to the invention thus allows the formation of wall-fouling gels to be limited without recourse to dispersants as described in the prior art, notably in WO 9 523 821 and in US 2012/0263953.

The term “essentially suspended” or “essentially not dissolved” means that the 1,3-bis(4-phenoxybenzoyl)benzene and/or 1,4-bis(4-phenoxybenzoyl)benzene, where appropriate considered as a whole, have a mass fraction of less than 2%, preferentially less than 1%, more preferentially less than 0.5%, more preferentially less than 0.25%, and most preferably less than 0.1% of species dissolved in the reaction solvent relative to the total weight of species in the reaction solvent at a given time and temperature.

The acyl chloride is preferentially chosen from the group consisting of: terephthaloyl chloride, isophthaloyl chloride, phthaloyl chloride, phosgene, adipoyl dichloride, and compounds having the formula:

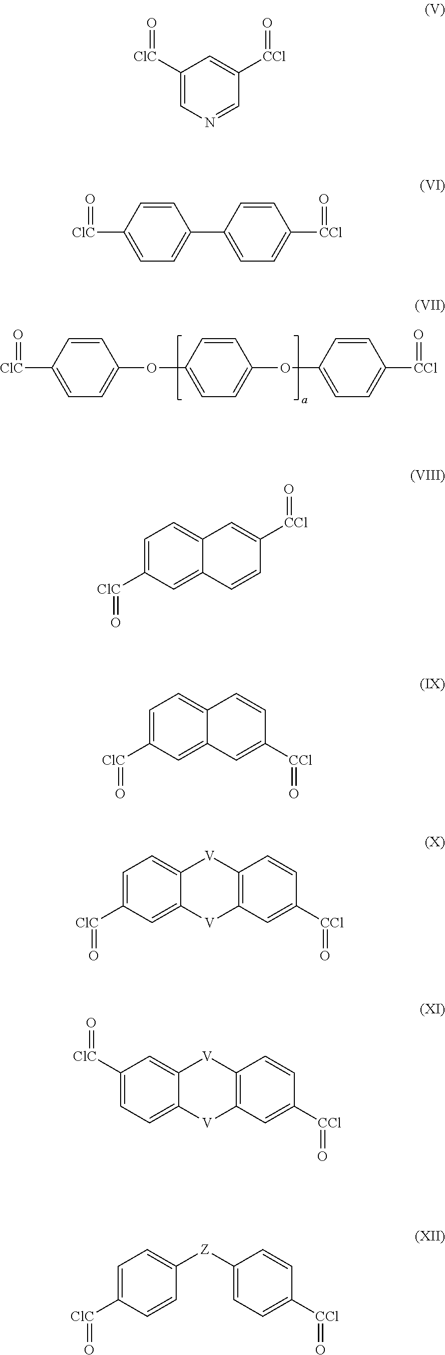

in which:
a is an integer ranging from 0 to 3;
V is chosen from: —O—, —S—, —(CF₂)_{q}—, —(CH₂)_{q}—, or —C((CH₃)₂)—;
Z is chosen from: —C(O)—, —SO₂—, —C(O)—C₆H₄—C(O)—, —O—(CF₂)_{q}—O—, —S—, —(CF₂)_{q}—, —(CH₂)_{q}—, or C—(CH₃)₂—; and in which q is an integer ranging from 1 to 20.

A certain number of measures may be taken to ensure that the acyl chloride(s) used have a satisfactory degree of purity. Specifically, acyl chlorides are readily hydrolyzable species and may notably contain a certain amount of hydrolyzed species as impurities if they are not stored and/or handled under appropriate conditions.

In particular, the acyl chlorides must not be placed in contact with water and/or a humid atmosphere at any time before being placed in the reactor. It may thus be advantageous to store the acyl chlorides in a leaktight container without contact with ambient air, or alternatively in a container containing dry air. Advantageously, the acyl chlorides may be kept under a dry nitrogen atmosphere before being placed in the reactor, so as to avoid contact with ambient air.

Hydrolyzed forms of acyl chlorides are difficult to analyze and quantify. It turned out that a practical and rapid method for ensuring the purity level of acyl chlorides consisted in dissolving them in a solvent, notably a reaction solvent, for example ortho-dichlorobenzene, and analyzing the haze of the mixture. Specifically, a high haze value obtained by this test indicates a large amount of insoluble contaminants, mainly hydrolyzed forms.

Consequently, the acyl chloride or acyl chloride mixture used is preferentially such that, 10 minutes after introducing it at a reference concentration of 6.5% by weight in anhydrous reaction solvent, at a temperature of 20° C., the mixture obtained has a haze of less than 500 NTU (nephelometric turbidity units). The haze values are given with reference to a solvent sample not comprising any acyl chloride.

According to certain embodiments, the acyl chloride or acyl chloride mixture used is preferentially such that, 10 minutes after introducing it at a reference concentration of 6.5% by weight in anhydrous reaction solvent, at a temperature of 20° C., the mixture obtained has a haze of less than 200 NTU, preferentially less than 100 NTU, very preferentially less than 50 NTU, and more preferably less than 20 NTU.

According to embodiments in which the polyether ketone ketone consists essentially of, or consists of, the repeating units of formulae (I) and/or (II), the acyl chloride or acyl chloride mixture consists essentially of, or consists of, terephthaloyl chloride, isophthaloyl chloride or a mixture of terephthaloyl chloride and isophthaloyl chloride.

The aromatic ether is 1,3-bis(4-phenoxybenzoyl)benzene or 1,4-bis(4-phenoxybenzoyl)benzene or a mixture of aromatic ethers comprising at least 50 mol % of an aromatic ether chosen from:
1,3-bis(4-phenoxybenzoyl)benzene having the formula:

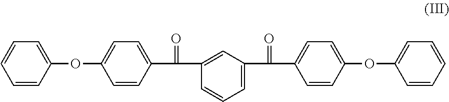 [SMILES: O=C(c1ccc(Oc2ccccc2)cc1)c1cccc(C(=O)c2ccc(Oc3ccccc3)cc2)c1]

1,4-bis(4-phenoxybenzoyl)benzene having the formula:

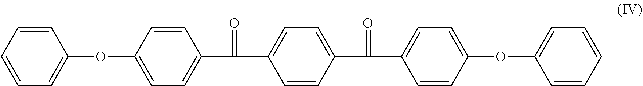 [SMILES: O=C(c1ccc(Oc2ccccc2)cc1)c1ccc(C(=O)c2ccc(Oc3ccccc3)cc2)cc1]

or mixtures thereof; relative to the total number of moles of aromatic ether(s).

In the case where the mixture of aromatic ethers comprises a mixture of 1,3-bis(4-phenoxybenzoyl)benzene and 1,4-bis(4-phenoxybenzoyl)benzene, the mixture of aromatic ethers comprises at least 50 mol % of 1,3-bis(4-phenoxybenzoyl)benzene and 1,4-bis(4-phenoxybenzoyl)benzene considered as a whole, relative to the total number of moles of aromatic ethers.

According to certain embodiments, the aromatic ether or the mixture of aromatic ethers comprises at least 60 mol %, or at least 70 mol %, or at least 80 mol %, or at least 90 mol %, or at least 95 mol % of 1,3-bis(4-phenoxybenzoyl)benzene and/or 1,4-bis(4-phenoxybenzoyl)benzene, where appropriate considered as a whole, relative to the total number of moles of aromatic ether(s).

According to certain embodiments, a mixture of aromatic ethers is used comprising, in addition to an ether chosen from 1,3-bis(4-phenoxybenzoyl)benzene and/or 1,4-bis(4-phenoxybenzoyl)benzene, another aromatic ether chosen from the list consisting of: diphenyl ether, 4,4′-diphenoxybenzophenone, 3,3′-diphenoxybenzophenone, 3,4′-diphenoxybenzophenone, or the product of the reaction by electrophilic Friedel-Crafts substitution of two molecules, notably the same two molecules, chosen from: diphenyl ether, 4,4′-diphenoxybenzophenone, 3,3′-diphenoxybenzophenone, 3,4′-diphenoxybenzophenone with an acyl chloride molecule, the acyl chloride preferably being chosen from the list described previously (with the exception of isophthaloyl or terephthaloyl chloride in the case of diphenyl ether, since the reaction gives 1,3-bis(4-phenoxybenzoyl)benzene and 1,4-bis(4-phenoxybenzoyl)benzene, respectively).

According to certain embodiments, a mixture of aromatic ethers is used. It is formed from: 1,3-bis(4-phenoxybenzoyl)benzene and/or 1,4-bis(4-phenoxybenzoyl)benzene, considered where appropriate as a whole, and: diphenyl ether and/or 4,4′-diphenoxybenzophenone. The mixture may comprise up to 20 mol %, preferentially up to 10 mol % and more preferably up to 5 mol % of diphenyl ether and/or 4,4′-diphenoxybenzophenone, where appropriate considered as a whole, relative to the total number of moles of aromatic ethers.

The presence of diphenyl ether and/or 4,4′-diphenoxybenzophenone in addition to: 1,3-bis(4-phenoxybenzoyl)benzene and/or 1,4-bis(4-phenoxybenzoyl)benzene allows the ratio of ether to ketone groups in the polymer to be increased, compared with embodiments in which only 1,3-bis(4-phenoxybenzoyl)benzene and/or 1,4-bis(4-phenoxybenzoyl)benzene are used.

According to certain embodiments, a mixture of aromatic ethers is used. It is formed from: 1,3-bis(4-phenoxybenzoyl)benzene and/or 1,4-bis(4-phenoxybenzoyl)benzene and: diphenyl ether. The mixture may comprise up to 20 mol %, preferentially up to 10 mol %, more preferably up to 5 mol %, and extremely preferably up to 1 mol % of diphenyl ether, relative to the total number of moles of aromatic ethers.

According to certain embodiments, a mixture of aromatic ethers is used. It consists of 1,3-bis(4-phenoxybenzoyl)benzene and 1,4-bis(4-phenoxybenzoyl)benzene.

According to certain embodiments, a mixture of aromatic ethers is used. It consists of: 1,4-bis(4-phenoxybenzoyl)benzene and diphenyl ether. The mixture may comprise up to 20 mol %, preferentially up to 10 mol %, more preferably up to 5 mol %, and extremely preferably up to 1 mol % of diphenyl ether, relative to the total number of moles of aromatic ethers.

According to certain embodiments, the aromatic ether is solely 1,4-bis(4-phenoxybenzoyl)benzene.

According to certain embodiments, a mixture of aromatic ethers is used. It consists of: 1,3-bis(4-phenoxybenzoyl)benzene and diphenyl ether. The mixture may comprise up to 20 mol %, preferentially up to 10 mol %, more preferably up to 5 mol %, and extremely preferably up to 1 mol % of diphenyl ether, relative to the total number of moles of aromatic ethers.

According to certain embodiments, the aromatic ether is solely 1,3-bis(4-phenoxybenzoyl)benzene.

According to certain embodiments, the aromatic ether is solely 1,4-bis(4-phenoxybenzoyl)benzene. A polyether ketone ketone having a ratio T:J of from 50:50 to 100:0 may be obtained by means of a mixture of isophthaloyl chloride and terephthaloyl chloride and by adjusting the isophthaloyl chloride/terephthaloyl chloride ratio.

According to certain embodiments, the acyl chloride is solely terephthaloyl chloride. A polyether ketone ketone with a ratio of T:J of from 50:50 to 100:0 may be obtained by means of a mixture of 1,3-bis(4-phenoxybenzoyl)benzene and 1,4-bis(4-phenoxybenzoyl)benzene and by adjusting the ratio of 1,3-bis(4-phenoxybenzoyl)benzene to 1,4-bis(4-phenoxybenzoyl)benzene.

In a similar manner, according to certain embodiments, the aromatic ether is solely 1,3-bis(4-phenoxybenzoyl)benzene (or, respectively, the acyl chloride is solely isophthaloyl chloride). A polyether ketone ketone having a ratio T:J of from 0:100 to 50:50 may be obtained by adjusting the ratio of isophthaloyl chloride to terephthaloyl chloride (or, respectively, by adjusting the ratio of 1,3-bis(4-phenoxybenzoyl)benzene to 1,4-bis(4-phenoxybenzoyl)benzene).

The Lewis acid may be chosen from the group consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof.

Preferentially, only one type of Lewis acid is used in the polymerization reaction.

Among the Lewis acids mentioned above, aluminum trichloride, boron trichloride, aluminum tribromide, titanium tetrachloride, antimony pentachloride, ferric chloride, gallium trichloride and molybdenum pentachloride are preferred.

Aluminum trichloride is particularly preferred.

Preferably, the Lewis acid is added in solid form. Alternatively, it may also be added in suspension or colloid form, i.e. as a heterogeneous mixture of solid particles of Lewis acid in a solvent, or in solution form, i.e. as a homogeneous mixture in a solvent. The solvent for the suspension/colloid or for the solution is advantageously the reaction solvent.

According to certain variants, the Lewis acid is added in particulate form, such as in powder form (having, for example, a Dv80 of less than 1 mm and preferably a Dv50 of less than 0.5 mm). The parameters Dv80 and Dv50 are, respectively, the particle sizes at the 80th and 50^{th} percentiles (by volume) of the cumulative particle size distribution of the Lewis acid particles. These parameters may notably be determined by screening.

The Lewis acid used in the process according to the invention preferably has a degree of purity such that it comprises less than 0.1% by weight of insoluble matter, and more preferentially less than 0.05% by weight of insoluble matter, as measured gravimetrically, when it is introduced with stirring into water at a concentration of 11% by weight at 20° C. and substantially dissolved.

The reaction solvent may be chosen from the group consisting of: ortho-dichlorobenzene, 1,2,4-trichlorobenzene, 1,2,3-trichlorobenzene, ortho-difluorobenzene, and mixtures thereof.

Among the reaction solvents mentioned above, ortho-dichlorobenzene, trichlorobenzene, 1,2,3-trichlorobenzene and ortho-difluorobenzene are preferred. ortho-Dichlorobenzene is particularly preferred.

The reaction solvent preferably contains less than 500 ppm by weight of water so as to limit the hydrolysis reaction of the acyl chloride or of the mixture of acyl chlorides. Advantageously, the reaction solvent contains less than 250 ppm by weight of water, preferably less than 150 ppm by weight of water, more preferentially less than 100 ppm by weight of water, and even more preferentially less than 50 ppm by weight of water.

In preferred variants, the aromatic ether or the mixture of aromatic ethers also preferably contains less than 500 ppm by weight of water so as to limit the hydrolysis reaction of the acyl chloride or the mixture of acyl chlorides. The same ranges of preferred values as for the reaction solvent apply mutatis mutandis to the aromatic ether or to the mixture of aromatic ethers.

In more preferred variants, the reaction solvent and the aromatic ether or the mixture of aromatic ethers comprise in total less than 500 ppm by weight of water so as to limit the hydrolysis reaction of the acyl chloride or the mixture of acyl chlorides. The same ranges of preferred values as for the reaction solvent apply mutatis mutandis to the reaction solvent and the aromatic ether or mixture of aromatic ethers, under consideration as a whole.

In order to ensure the absence of traces of water in the reactor, the process advantageously comprises a preliminary drying step, i.e. reducing the water content of the reaction solvent and/or of the aromatic ether or the mixture of aromatic ethers, before placing them in contact with the acyl chloride or with the mixture of acyl chlorides. Means for performing this preliminary drying step include, for example, distillation of the chemical compounds, or placing them in contact with molecular sieves or else placing them in contact with a dehydrating agent such as a small amount of aluminum chloride.

The use of one or more chain-limiting agents in the reaction medium is optional. Their addition allows better control of the degree of polymerization and thus of the viscosity of the polymer to be manufactured. It also allows better control of the chain ends of the polymer and, where appropriate, ensures better stability, notably better thermal stability, of the polymer.

An additional advantage of the process according to the invention compared with processes of the prior art, notably those involving the preparation of a cold premix and dispersion of this premix in preheated reaction solvent, is that it makes it possible to obtain a polymer having a higher proportion of polymer end chains originating from the chain-limiting agent for a given viscosity.

Two types of chain-limiting agent may be used: a nucleophilic chain-limiting agent or an electrophilic chain-limiting agent.

According to certain embodiments, the chain-limiting agent is a nucleophilic chain-limiting agent. The nucleophilic chain-limiting agent may notably be chosen from compounds having the following chemical formula:

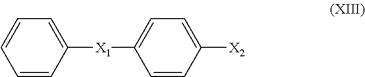

in which:
X₁ represents: a covalent bond, —O—, or —S—; and
X₂ represents C₆H₅CO or C₆H₅SO₂;
or of the following chemical formula:

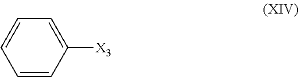

in which:
X₃ is a halogen, an alkyl group or an alkoxy group containing from 1 to 10 carbon atoms.

Preferentially, the nucleophilic chain-limiting agent is chosen from the group consisting of: 4-phenoxybenzophenone, 4-phenoxydiphenyl sulfone, anisole, fluorobenzene, chlorobenzene, biphenyl, toluene, and a mixture thereof.

A particularly advantageous nucleophilic chain-limiting agent is 4-phenoxybenzophenone.

According to certain embodiments, the chain-limiting agent is an electrophilic chain-limiting agent. The electrophilic chain-limiting agent may notably be chosen from compounds of the following formula:

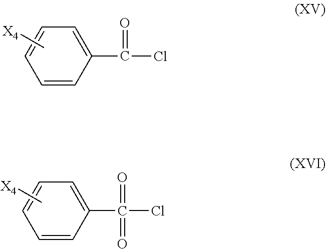

in which:
X₄ represents: a hydrogen atom, a halogen atom, an alkyl or alkoxy group containing from 1 to 10 carbon atoms, or a nitro, C₆H₅CO or C₆H₅SO₂ group; or of the following formula:

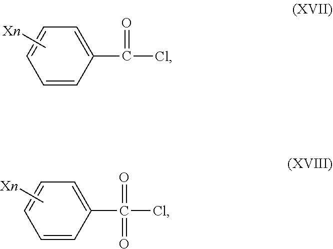

in which:
Xn represents n groups, n being an integer chosen between 2 and 5, each group being independently chosen from: a halogen atom, an alkyl or alkoxy group containing from 1 to 10 carbon atoms, or a nitro, C₆H₅CO or C₆H₅SO₂ group.

Preferentially, the electrophilic chain-limiting agent is chosen from the group consisting of: benzoyl chloride, acetyl chloride, 3,5-dichlorobenzoyl chloride, 3,5-difluorobenzoyl chloride, p-fluorobenzoyl chloride, p-chlorobenzoyl chloride, p-methoxybenzoyl chloride, benzenesulfonyl chloride, p-chlorobenzenesulfonyl chloride, p-methylbenzenesulfonyl chloride, 4-benzoylbenzoyl chloride, and a mixture thereof.

Advantageously, the chain-limiting agent is an electrophilic chain-limiting agent chosen from benzoyl chloride, p-fluorobenzoyl chloride, 3,5-difluorobenzoyl chloride, or a mixture thereof. These chain-limiting agents are readily measured out as they are in liquid form at room temperature, have a low cost price and ensure good thermal stability of the polymer.

According to certain embodiments, benzoyl chloride is used as chain-limiting agent.

According to certain embodiments, p-fluorobenzoyl chloride is used as chain-limiting agent.

According to certain embodiments, 3,5-difluorobenzoyl chloride is used as chain-limiting agent.

The use of a dispersant in the reaction medium is optional. The process according to the invention generally eliminates the need to use such agents, since it enables the fouling within the reactor to be effectively minimized via increased control of the reactor temperature. According to preferred embodiments, no dispersant is added to the reaction medium. This notably has several advantages: it avoids over-consumption of the Lewis acid introduced and/or facilitates the upgrading of the process effluents, notably the effluent containing the Lewis acid.

Since the polymerization reaction is a polycondensation, the aromatic ether or mixture of aromatic ethers is introduced into the reaction mixture under conditions which are substantially stoichiometric relative to the acyl chloride or mixture of acyl chlorides.

The molar proportion of aromatic ether(s) relative to the acyl chloride(s) which have been introduced in total into the reaction mixture at the end of the step of placing in contact is preferentially from 0.9/1.1 to 1.1/0.9.

According to advantageous embodiments, the aromatic ether(s) are introduced in excess relative to the acyl chloride(s), preferentially with a mole ratio of aromatic ether(s) relative to acyl chloride(s) of 1.001 to 1.1. In these embodiments, if a chain-limiting agent is used, it is preferentially an electrophilic chain-limiting agent, for example, and advantageously, benzoyl chloride or p-fluorobenzoyl chloride or 3,5-difluorobenzoyl chloride.

The mole ratio of aromatic ether(s) relative to the reaction solvent(s) which have been introduced in total into the reaction mixture at the end of the polymerization is preferentially at least equal to 0.005, very preferentially greater than or equal to 0.008, and more preferably greater than or equal to 0.010.

As detailed below, the process according to the invention makes it possible to obtain polymer particles of generally smaller size and with a generally more homogeneous distribution than prior art processes involving the preparation of a cold premix followed by dispersion of this premix in preheated reaction solvent. A more compact suspension of polymer particles in the reaction solvent may thus be obtained, enabling the process to be performed in a generally smaller amount of reaction solvent.

Thus, according to certain embodiments, the mole ratio of aromatic ether(s) relative to the reaction solvent(s) which have been introduced in total into the reaction mixture at the end of the polymerization is greater than or equal to 0.010, or greater than or equal to 0.011, or greater than or equal to 0.012, or greater than or equal to 0.013, or greater than or equal to 0.014, or greater than or equal to 0.015, or greater than or equal to 0.016, or greater than or equal to 0.17.

In contrast, given that the less solvent the reaction mixture contains, the more likely it is to form fouling during polymerization, especially in the absence of dispersant, the mole ratio of aromatic ether(s) relative to the reaction solvent(s) which have been introduced in total into the reaction mixture at the end of polymerization is preferentially less than or equal to 0.030, very preferentially less than or equal to 0.025 and extremely preferably less than or equal to 0.022.

Thus, according to certain embodiments, the mole ratio of aromatic ether(s) relative to the total reaction solvent(s) introduced into the reaction mixture is from 0.005 to 0.030, preferentially from 0.008 to 0.025, and extremely preferably from 0.010 to 0.022. The mole ratio of aromatic ether(s) relative to the reaction solvent(s) introduced in total into the reaction mixture may notably be from 0.011 to 0.022, from 0.012 to 0.022, from 0.013 to 0.022, from 0.014 to 0.022, from 0.015 to 0.022, from 0.016 to 0.022, or from 0.017 to 0.022.

The mole ratio of Lewis acid relative to the aromatic ether(s) that have been introduced in total into the reaction mixture at the end of the step of placing in contact is preferentially from 5.0 to 7.0, and very preferentially from 5.5 to 6.5.

The process according to the invention involves placing in contact the chemical compounds involved in the polymerization reaction. This step notably involves placing in contact the reagents: aromatic ether(s), acyl chloride(s) and Lewis acid in all or some of the reaction solvent. These various compounds can theoretically be mixed together in any order, so that at the end of the step of placing in contact, the 1,3-bis(4-phenoxybenzoyl)benzene and/or the 1,4-bis(4-phenoxybenzoyl)benzene, considered where appropriate as a whole, are essentially not dissolved in the reaction solvent.

For the purposes of the invention, the term “reaction mixture” is used when all or part of the aromatic ether(s), all or part of the acyl chloride(s) and all or part of the Lewis acid are placed in contact in all or part of the solvent. In other words, the “reaction mixture” begins to exist at the point at which polymerization might be initiated, i.e. when all or part of the aromatic ether(s), all or part of the acyl chloride(s) and all or part of the Lewis acid have been placed in contact.

The step of placing in contact ends when all the aromatic ether or the mixture of aromatic ethers, the acyl chloride or the mixture of acyl chlorides and the Lewis acid have been placed in contact. Thus, the reaction mixture at the end of the step of placing in contact comprises all of the aromatic ether or mixture of aromatic ethers, all of the acyl chloride or mixture of acyl chlorides, all of the Lewis acid, all or part of the reaction solvent, and optionally all or part of the chain limiter or mixture of chain limiters.

According to certain advantageous embodiments, the reaction mixture is maintained at a temperature T₀ during the step of placing the compounds in contact, so as to ensure that the 1,3-bis(4-phenoxybenzoyl)benzene and/or 1,4-bis(4-phenoxybenzoyl)benzene, under consideration where appropriate as a whole, are essentially not dissolved in the reaction solvent at the end of the step of placing in contact.

The temperature T₀ is advantageously less than or equal to 5° C. It is preferentially less than or equal to 0° C., and very preferentially less than or equal to −5° C.

According to certain embodiments, all of the reaction solvent is introduced during the step of placing in contact. This is notably the case when the reaction solvent plays no direct role in heating the reaction mixture to reach the temperature Tp.

According to other embodiments, only a part of the reaction solvent is introduced during the step of placing in contact, the other part of the solvent may, inter alia, be added just after the end of placing in contact and before, or at the start of, the gradual heating step. Alternatively, or in addition, the other part of the solvent may be added during the gradual heating step to contribute directly to the performance of this step. In other words, reaction solvent preheated to a temperature higher than the temperature of the reaction mixture may be added thereto so as to increase its temperature.

According to certain embodiments, a mass fraction of from 0.15 to 0.95 of solvent may be introduced before the end of the step of placing in contact.

According to certain embodiments, a mass fraction of from 0.15 to 0.25, or from 0.25 to 0.40, or from 0.40 to 0.55, or from 0.55 to 0.70, or from 0.70 to 0.85, or from 0.85 to 0.95 of the reaction solvent may be introduced before the end of the step of placing in contact.

According to advantageous embodiments, from 0.15 to 0.55, and preferentially from 0.25 to 0.40, of the reaction solvent is introduced before the end of the step of placing in contact. These embodiments notably make it possible to ensure that the 1,3-bis(4-phenoxybenzoyl)benzene and/or 1,4-bis(4-phenoxybenzoyl)benzene, considered as a whole, are essentially in the form of a suspension at the end of the step of placing in contact.

According to advantageous embodiments, the various compounds, notably the reagents, may be added in two phases.

In a first phase, two of the reagents are mixed together in total. In a second phase, the third reagent is added in total to the previously obtained mixture. The medium may then be maintained at the temperature less than or equal to T₀ between at the latest the start of the second phase where the third reagent starts to be added and the end of the second phase where the third reagent stops being added.

According to a first embodiment, said first phase involves preparing a mixture comprising all of the aromatic ether or mixture of aromatic ethers with all of the acyl chloride or mixture of acyl chlorides, in all or some of the reaction solvent. The second phase involves adding all the Lewis acid to the mixture obtained in the first phase.

According to a second embodiment, said first phase involves preparing a mixture comprising all of the acyl chloride or the mixture of acyl chlorides with all of the Lewis acid, in all or some of the reaction solvent. The second phase involves adding all of the aromatic ether or mixture of aromatic ethers to the mixture obtained in the first phase.

The section below describes in detail these two particularly advantageous embodiments for performing the step of placing the chemical compounds in contact in a reactor. The process according to the invention is by no means limited to these illustrative embodiments.

The first advantageous embodiment may be performed according to the following sequence: Firstly, all or some of the reaction solvent is introduced into the reactor. Secondly, the aromatic ether or mixture of aromatic ethers is added and dispersed in the reaction solvent in the reactor with stirring. Thirdly, in order to ensure that there are no traces of water in the reactor, distillation is performed and the reactor headspace is also inertized with nitrogen. Alternatively or additionally, a dehydrating agent, notably a small amount of aluminum chloride, may be added in order to eliminate the last traces of water. The reaction of aluminum chloride with water forms aluminum hydroxide and hydrogen chloride (according to this alternative, in this step the medium already contains aluminum chloride in very small amounts, or even in trace amounts). Fourthly, the acyl chloride or mixture of acyl chlorides is placed in the reactor with stirring. Fifthly, the Lewis acid is introduced with stirring. Since complexation of the Lewis acid with the acyl chloride(s) is an exothermic reaction, the Lewis acid is added to the reactor sufficiently slowly so that the reaction mixture can be maintained at a temperature of less than or equal to 5° C. The step of adding Lewis acid may generally last from 15 minutes to 12 hours. On an industrial scale, the step of adding Lewis acid preferentially lasts from 25 minutes to 6 hours, and more preferably from 30 minutes to 4 hours.

Once all of the Lewis acid has been totally introduced, an optional step of homogenizing the reaction mixture at a temperature less than or equal to T₀ may be observed, where appropriate. This optional homogenization step may preferentially last less than 15 minutes, or less than 10 minutes, or less than 5 minutes.

The second advantageous embodiment may be performed according to the following sequence:

Firstly, all or some of the reaction solvent is introduced into the reactor. Secondly, in order to ensure that there are no traces of water in the reactor, distillation is performed and the reactor headspace is also inertized with nitrogen. Alternatively or additionally, a dehydrating agent, notably a small amount of aluminum chloride, may be added in order to eliminate the last traces of water. The reaction of aluminum chloride with water forms aluminum hydroxide and hydrogen chloride (according to this alternative, in this step the medium already contains aluminum chloride in very small amounts).

Thirdly, the acyl chloride or mixture of acyl chlorides is placed in the reactor with stirring. Fourthly, the Lewis acid is introduced with stirring. Since complexation of the Lewis acid with the acyl chloride(s) is an exothermic reaction, the Lewis acid is added to the reactor sufficiently slowly so that the reaction mixture can be maintained at a temperature of less than or equal to 5° C. The step of adding Lewis acid may generally last from 15 minutes to 12 hours. On an industrial scale, the step of adding Lewis acid preferentially lasts from 25 minutes to 6 hours, and more preferably from 30 minutes to 4 hours.

Fifthly, once all the Lewis acid has been fully introduced, the aromatic ether or mixture of aromatic ethers is introduced so as to form the reaction mixture.

An optional step of homogenizing the reaction mixture may be observed, where appropriate. This optional homogenization step may preferentially last less than 15 minutes, or less than 10 minutes, or less than 5 minutes.

The process according to the invention also comprises polymerization of the reaction mixture, the polymerization being performed, at least in part, at a temperature Tp greater than or equal to 50° C. A sufficiently high polymerization temperature allows rapid polymerization reaction kinetics. According to certain embodiments, the temperature Tp is greater than or equal to 55° C., or greater than or equal to 60° C., or greater than or equal to 65° C., or greater than or equal to 70° C., or greater than or equal to 75° C., or greater than or equal to 80° C., or greater than or equal to 85° C.

The temperature Tp is generally less than or equal to 120° C. so as to minimize parasitic reactions competing with the polymerization reaction. Preferentially, the temperature Tp is less than or equal to 100° C. The temperature Tp may notably be less than or equal to 95° C.

Advantageously, the temperature Tp may be chosen in a range from 50° C. to 65° C., or from 65° C. to 70° C., or from 70° C. to 75° C., or from 75° C. to 80° C., or from 80° C. to 85° C., or from 85° C. to 90° C., or from 90° C. to 95° C., or from 95° C. to 100° C., or from 100° C. to 120° C.

The reaction mixture is maintained, preferably with stirring, for a certain time at the temperature Tp until the desired degree of polymerization is obtained. The higher the temperature Tp, the shorter the time that the reaction mixture is held at Tp. This time generally ranges from 1 minute to 300 minutes, preferentially from 5 minutes to 180 minutes, and extremely preferably from 10 minutes to 100 minutes.

Once the reaction is completed to the desired degree of polymerization, the starting mixture is referred to as a “product mixture”.

The invention is characterized in that the process comprises a step of gradual heating of the reaction mixture until the polymerization reaction is accelerated, the gradual heating step being performed at an average heating rate chosen within a range from 0.65° C./minute to 2.5° C./minute.

The gradual heating step is preferentially performed at an average heating rate ranging from 0.70° C./min to 2.2° C./min, preferentially at an average heating rate ranging from 0.75° C./min to 2.0° C./min, and more preferably at an average heating rate ranging from 0.8° C./min to 1.8° C./min.

The gradual heating step is performed between an initial temperature Tᵢ and a final temperature T_{f}, the temperatures Tᵢ and T_{f} being such that: T₀≤Tᵢ<T_{f}≤Tₚ.

According to certain embodiments, T₀≤Tᵢ<T₀+30° C., or T₀≤Tᵢ<T₀+20° C., or T₀≤Tᵢ<T₀+15° C.

According to certain embodiments, Tₚ−45<T_{f}≤Tₚ, or Tₚ−35<T_{f} Tₚ, or Tₚ−25<T_{f}≤Tₚ, or Tₚ−15<T_{f}≤Tₚ, or Tₚ−10<T_{f}≤Tₚ.

According to certain embodiments, T_{f}-Tᵢ>25° C., T_{f}-Tᵢ≥30° C., or T_{f}-Tᵢ≥35° C., or T_{f}-Tᵢ≥40° C.

According to particular embodiments, the gradual heating step may be performed between T₀ and Tₚ.

Acceleration of the polymerization reaction is a feature of the process according to the invention. It takes place around a temperature T*, which itself depends, at least in part, on the performance of the gradual heating step itself.

The temperature T* may be evaluated by the fact that the acceleration of polymerization is marked by a sudden increase in hydrogen chloride production.

Alternatively, the temperature T* may be evaluated by the fact that polymerization acceleration is marked by a sudden increase in the flow of heat emitted by the reaction mixture.

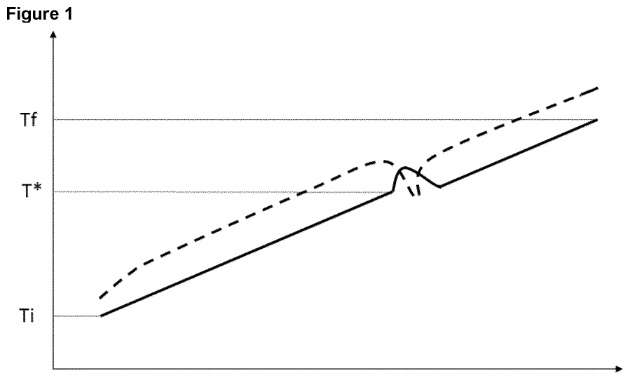

To illustrate the latter, FIG. 1 represents the jacket temperature (dotted line) for a jacketed reactor, such as the one used to perform the examples, and also the temperature of the reaction mixture within the reactor (solid curve), as a function of time.

A nominal temperature ramp is set so as to obtain a temperature ramp within the reactor ranging from a temperature Tᵢ to a temperature T_{f}.

The temperature T* corresponds to the temperature at which the temperature of the reaction mixture rises faster than the temperature imposed by the reactor's temperature control means, forcing the reactor to temporarily cool the reaction mixture.

One consequence of accelerated polymerization is a very rapid increase in the viscosity of the reaction mixture shortly after having reached the temperature T*.

It is estimated that the temperature T* that may generally be observed for the processes according to the invention is between 20° C. and 80° C. The temperature T* may notably be from 20° C. to 25° C., or from 25° C. to 35° C., or from 35° C. to 45° C., or from 45° C. to 55° C., or from 55° C. to 65° C., or from 65° C. to 75° C., or from 75° C. to 80° C.

According to certain embodiments, Tᵢ≤T*−10° C., preferentially Tᵢ≤T*−20° C., and extremely preferably Tᵢ≤T*−25° C.

According to certain embodiments, T*+5° C.≤Tₚ, preferentially T*+10° C.≤Tₚ, and extremely preferably T*+15° C.≤Tₚ.

According to certain embodiments, the gradual heating step may be performed by means of a sequence of temperature steps, the temperature difference between each step not exceeding 15° C., preferentially not exceeding 10° C., and very preferentially not exceeding 5° C. Successive stages may be obtained by successive addition of a small fraction of preheated reaction solvent.

According to certain embodiments, the gradual heating step is performed with one or more temperature ramps at a heating rate ranging from 0.65° C./min to 2.5° C./min, preferentially with a heating rate ranging from 0.70° C./min to 2.2° C./min, preferentially with a heating rate ranging from 0.75° C./min to 2.0° C./min, and more preferably with a heating rate ranging from 0.8° C./min to 1.8° C./min.

Such temperature ramps may be obtained with the aid of heating means incorporated into the reactor, the addition of a fraction of the preheated reaction solvent, or a combination of both means.

According to certain embodiments, the reaction solvent may be preheated to a temperature possibly higher than the temperature Tₚ and added to the reaction mixture, either continuously or batchwise.

According to certain embodiments, the gradual heating step is performed with a single temperature ramp at a heating rate ranging from 0.65° C./min to 2.5° C./min, preferentially with a heating rate ranging from 0.70° C./min to 2.2° C./min, preferentially with a heating rate ranging from 0.75° C./min to 2.0° C./min, and more preferably with a heating rate ranging from 0.8° C./min to 1.8° C./min, between Tᵢ and T_{f}.

According to particular embodiments, the gradual heating step may be performed with a single temperature ramp between −5° C. and 120° C., or between −5° C. and 100° C., or between −5° C. and 95° C., or between −5° C. and 90° C., or between −5° C. and 85° C., or between −5° C. and 80° C., or between −5° C. and 75° C., or between −5° C. and 70° C., or between −5° C. and 65° C., or between −5° C. and 60° C., or between −5° C. and 55° C., or between −5° C. and 50° C., or between 5° C. and 120° C., or between 5° C. and 100° C., or between 5° C. and 95° C., or between 5° C. and 90° C., or between 5° C. and 85° C., or between 5° C. and 80° C., or between 5° C. and 75° C., or between 5° C. and 70° C., or between 5° C. and 65° C., or between 5° C. and 60° C., or between 5° C. and 55° C., or between 5° C. and 50° C., or between 15° C. and 120° C., or between 15° C. and 100° C., or between 15° C. and 95° C., or between 15° C. and 90° C., or between 15° C. and 85° C., or between 15° C. and 80° C., or between 15° C. and 75° C., or between 15° C. and 70° C., or between 15° C. and 65° C., or between 15° C. and 60° C., or between 15° C. and 55° C., or between 15° C. and 50° C., or between 25° C. and 120° C., or between 25° C. and 100° C., or between 25° C. and 95° C., or between 25° C. and 90° C., or between 25° C. and 85° C., or between 25° C. and 80° C., or between 25° C. and 75° C., or between 25° C. and 70° C., or between 25° C. and 65° C., or between 25° C. and 60° C., or between 25° C. and 55° C., or between 25° C. and 50° C.

According to certain embodiments, the gradual heating step may be performed by a combination of temperature stages, and temperature ramps by the abovementioned means.

In the embodiments in which a chain-limiting agent is used, this chain-limiting agent may be introduced before or during the polymerization.

It may be introduced all at once, or in a portionwise manner.

Advantageously, the chain-limiting agent is introduced in its entirety before reaching the temperature T*. More preferentially, the chain-limiting agent is introduced in its entirety before the gradual heating step is performed.

According to certain embodiments, the chain-limiting agent may be introduced in its entirety during the placing in contact of the reagents.

In particular, in the two embodiments of placing the reagents in contact described in detail above, the chain-limiting agent may advantageously be introduced before the last reagent is introduced.

According to advantageous embodiments, the hydrogen chloride produced during the polymerization reaction is extracted from the reactor during polymerization so as to promote the polymerization reaction. To this end, all or some of the polymerization may be performed under reduced pressure, at an absolute pressure of less than or equal to 900 mbar, or less than or equal to 800 mbar, or less than or equal to 700 mbar, or less than or equal to 600 mbar, or less than or equal to 500 mbar, or less than or equal to 400 mbar, or less than or equal to 300 mbar, or less than or equal to 200 mbar, or less than or equal to 100 mbar. Alternatively, or additionally, an inert gas, for example helium, argon or dinitrogen, is bubbled into the reaction mixture. However, this method is not preferred as it creates additional turbulence in the reaction mixture and makes it more difficult to control the temperature within the reactor.

The process may be performed in one reactor or a succession of several reactors.

According to certain embodiments, the placing in contact, the gradual heating step and the polymerization are performed in a single reactor.

According to certain embodiments, the placing in contact is performed in a first reactor and the gradual heating step and the polymerization are performed in a second reactor.

Reactors that can be used to perform the present invention may be, for example, glass reactors, enamelled reactors or reactors with corrosion-resistant metallurgy.

The reactors preferentially have temperature control means and means for measuring the temperature therein. The reactors may notably include one or more temperature sensors therein and be configured to cool and/or heat the reaction medium.

The reactors that may be used to perform the present invention are preferably equipped with a stirring device such as a mechanical stirrer (which may, for example, comprise one or more stirring rotors) or a recirculation loop with a pump. The reaction mixture is preferentially stirred during the placing in contact of the reagents, the gradual heating step and the polymerization to allow good homogenization of the chemical compounds and also homogeneous heat transfer within the reaction mixture.

The reactor that may be used for the gradual heating step and the polymerization advantageously comprises a dual-flow stirring system which keeps the reaction mixture in motion, notably at the level of the side walls of the reactor, and also a tank bottom turbine which keeps the reaction mixture in motion, notably at the level of the tank bottom wall, and thus prevents accelerated fouling of the reactor.

After the polymerization reaction has been completed to the desired degree of polymerization, the process of the invention may comprise purification of the polyether ketone ketone from the product mixture in a manner known per se. This has, for example, already been described in EP3655458.

In particular, this purification makes it possible to separate the solvent, the catalyst, the unreacted reagents and any reaction by-products from the polymer per se.

In particular, purification generally comprises a step of placing the product mixture in contact with a protic solvent, so as to recover a first phase comprising the Lewis acid and a second phase comprising the polyether ketone ketone.

The protic solvent may be an aqueous solution. The aqueous solution may simply be water. Alternatively, the aqueous solution may be an acidic solution, such as a hydrochloric acid solution. Preferably, the pH of the aqueous solution is not greater than 3, or not greater than 2. Dissociation of the polyether ketone ketone/Lewis acid complex is more efficient when an acidic solution is used.

Solvent mixtures may also be used, such as an aqueous-organic solvent, for example an aqueous solution mixed with methanol, ethanol, isopropanol or acetic acid. Preferentially, a mixture of an aqueous solution and an alcohol, notably methanol, ethanol or isopropanol, comprising 95% to 60% by weight, preferably 80% to 95% by weight of alcohol, is used.

Placing the product mixture in contact with the protic solvent produces a first phase (containing the protic solvent) and a second phase (containing the reaction solvent). The Lewis acid is mainly present in dissolved form in the first phase, whereas the polyether ketone ketone is mainly present in precipitated form in the second phase.

The polyether ketone ketone can then be recovered by solid/liquid separation of the second phase. Advantageously, the solid/liquid separation is performed by centrifugal filtration.

The dry solids content of the crude polyether ketone ketone product at the end of the solid/liquid separation step is preferably between 10% by weight and 90% by weight, more preferably between 20% and 80% by weight and even more preferably between 30% and 60% by weight.

The liquid effluents, containing the first phase and the second phase, can optionally be separated so as to be recovered separately, preferably by decantation, for possible reuse. A surfactant may be added in order to facilitate the phase separation. When the Lewis acid is aluminum trichloride, the first phase advantageously contains it in suitable proportions so that it can be directly recycled for use in a water treatment/sludge flocculation process.

According to preferred embodiments, the crude polyether ketone ketone product at the end of the preceding solid/liquid separation step can be further purified by washing with one or more protic solvents.

The protic solvent at this stage is preferably water or an aqueous solution. However, in other variants, the protic solvent at this stage may also be an organic solvent, optionally mixed with water. Linear or branched aliphatic alcohols such as methanol, ethanol and isopropanol are particularly preferred organic solvents. These organic solvents may optionally be mixed with each other and/or with water.

After the washing step or concomitantly with the washing step, a further solid/liquid separation step may be performed.

According to an advantageous embodiment, a centrifugal filtration device is used, so that washing and solid/liquid separation can be performed concomitantly in the device, without resuspension of the product.

After the final solid/liquid separation, the recovered solid is advantageously dried.

The drying step may be performed conventionally, for example at a temperature ranging from 100° C. to 280° C., and under atmospheric pressure or, preferably, under reduced pressure, for example at a pressure of 30 mbar. After drying, the polyether ketone ketone generally has a proportion of reaction solvent of less than or equal to 50 ppm, preferentially less than or equal to 25 ppm, and more preferably less than or equal to 15 ppm by weight, relative to the weight of polymer.

The polymer manufactured according to the process of the invention generally has an inherent viscosity, measured at a concentration of 0.0005 g/mL in a 96.00% sulfuric acid solution (mass fraction) at 25° C. using a viscometer such as an Ubbelohde suspended-level viscometer (capillary inside diameter of 1.03 mm) according to the standard ISO 307-2009 applied to PEKK, of 0.4 to 2.0 dL/g, and preferentially of 0.7 to 1.5 dL/g.

According to certain embodiments, the polyether ketone ketone has an inherent viscosity of from 0.4 to 0.5 dL/g, or from 0.5 to 0.6 dL/g, or from 0.6 to 0.7 dL/g, or from 0.7 to 0.8 dL/g, or 0.8 to 0.9 dL/g, or 0.9 to 1.0 dL/g, or 1.0 dL/g to 1.1 dL/g, or 1.1 to 1.2 dL/g, or 1.2 to 1.3 dL/g, or 1.3 to 1.4 dL/g, or 1.4 to 1.5 dL/g.

According to particular embodiments, the polyether ketone ketone has an inherent viscosity of from 0.98 dL/g to 1.4 dL/g.

The polyether ketone ketone manufactured according to the invention has the advantage of not containing any dispersant(s), notably those described in WO 9 523 821 and in US 2012/0263953, in the form of impurity(ies).

The polyether ketone ketone according to the invention thus does not comprise benzoic acid or a derivative thereof, used as dispersant, as described in US 2012/0263953. The polyether ketone ketone notably does not contain any of the following compounds: benzoic acid, methylbenzoic acid, sodium
benzoate, magnesium benzoate, aluminum benzoate, methyl
benzoate and benzenesulfonic acid. In particular, the polyether ketone ketone does not contain any benzoic acid.

The polyether ketone ketone according to the invention thus also does not comprise any other polymer, used as dispersant, such as the polymers described in WO 9 523 821. The polyether ketone ketone notably does not contain any copolymers of aliphatic vinyl compounds and N-vinylpyrrolidone.

In the embodiments in which a chain-limiting agent is used in the polyether ketone ketone manufacturing process, for example benzoyl chloride, p-fluorobenzoyl chloride or 3,5-difluorobenzoyl chloride, the polyether ketone ketone has, for a given viscosity, a high proportion of chain ends derived from the limiting agent, relative to the polymers of the prior art.

The polyether ketone ketone preferentially satisfies the following inequality:

IV*FDC_{(LDC)}≥LIM;
in which:
IV represents the inherent viscosity of the polyether ketone ketone as measured according to the standard ISO 307-2009 and expressed in dL/g,
FDC_{(LDC)} represents the molar concentration of the group originating from the chain limiter relative to the total weight of the polymer, expressed as micro-equivalents of limiter per gram of polymer, and
LIM is a limit value, equal to at least 40.

According to certain embodiments, the value LIM is equal to 40, or equal to 41, or equal to 42, or equal to 43, or equal to 44, or equal to 45, or equal to 46, or equal to 47, or equal to 48, or equal to 49, or equal to 50.

The polyether ketone ketone obtained according to the process of the invention is generally in the form of flakes of fairly homogeneous size. In particular, and advantageously, the polymer has few large flakes. This is notably advantageous for facilitating purification. Specifically, the extraction of aluminum chloride and/or impurities resulting from polymerization is simpler and more efficient to perform on particles of reduced size. In addition, drying can also be performed more quickly.

According to certain embodiments, the polyether ketone ketone flakes form a powder for which the mass proportion of particles with a size strictly greater than 630 micrometers is less than or equal to 25%, preferentially less than or equal to 15%, and more preferentially less than or equal to 10%, relative to the total weight of powder, as obtained by screening using a sieve with a mesh size equal to 630 micrometers.

According to certain embodiments, the polyether ketone ketone flakes form a coarse powder for which the mass proportion of particles with a size strictly greater than 450 micrometers is less than or equal to 75%, preferentially less than or equal to 50%, more preferentially less than or equal to 25%, even more preferentially less than or equal to 20%, and most preferably less than or equal to 16%, relative to the total weight of powder, as obtained by screening using a sieve with a mesh size equal to 630 micrometers.

According to certain embodiments, the polyether ketone ketone flakes, forming a coarse powder, have a tapped density, as measured in the examples, of greater than or equal to 200 kg/m³. A sufficiently high tapped density has several advantages depending on the intended use. In granulation, it reduces the amount of air introduced into the extruder and improves the melt stability of the polymer. In laser sintering, after grinding into a fine powder, it improves the cohesion of the powder bed. The tapped density generally remains less than 400 kg/m³. It may notably be less than 350 kg/m³, or even less than or equal to 300 kg/m³.

In addition, according to certain embodiments, the polyether ketone ketone flakes, forming a coarse powder, have a BET specific surface area of less than or equal to 4 m²/g. The specific surface area may notably be less than or equal to 3 m²/g, or less than or equal to 2.5 m²/g. It generally remains above 0.1 m²/g. It may notably be greater than or equal to 1 m²/g.

### EXAMPLES

### Example 1

A jacketed reactor (R2) equipped with a stirrer comprising “two superposed dual-flow rotors” and a system for inertizing the headspace under a stream of nitrogen was used. ortho-Dichlorobenzene and 1,4-bis(4-phenoxybenzoyl)benzene were first added with stirring in the reactor R2 in a 1,4-bis(4-phenoxybenzoyl)benzene/ortho-dichlorobenzene mass proportion equal to 0.041.

Dynamic vacuum distillation (90° C., 150 mbar) and inertizing with nitrogen were performed to eliminate any trace of residual water in the reactor.

A mixture of terephthaloyl and isophthaloyl chlorides, in a molar proportion of terephthaloyl chloride to isophthaloyl chloride equal to 0.45, was then added with stirring to the reaction medium so as to be in substantially equimolar amounts, but slightly deficient relative to the 1,4-bis(4-phenoxybenzoyl)benzene. The molar proportion of 1,4-bis(4-phenoxybenzoyl)benzene relative to the mixture of terephthaloyl and isophthaloyl chlorides is equal to 1.03.

Benzoyl chloride was also added with stirring as chain limiter in a molar proportion relative to the 1,4-bis(4-phenoxybenzoyl)benzene equal to 0.042.

The reaction medium in reactor R2 was then cooled to −5° C. Solid aluminum trichloride was added slowly, over about 45 minutes, to the reaction medium with stirring, to form a reaction mixture, the temperature of the reaction mixture being maintained at about −5° C. throughout the addition step. The molar proportion of aluminum trichloride relative to the 1,4-bis(4-phenoxybenzoyl)benzene is equal to 6.3.

Once all the aluminum trichloride had been added, the temperature in reactor R2 was gradually increased in a temperature ramp of 0.8° C./min until a reaction mixture temperature equal to 90° C. was reached. The reaction mixture was then maintained at a temperature of 90° C. for a period of 30 minutes.

The product mixture was then cooled to a temperature of less than or equal to 50° C. It was purified by mixing with an aqueous hydrochloric acid solution with a pH 3 and solid/liquid separation using a filter. The crude polymer was then washed three times by resuspension and then filtration, the washing solutions used successively being methanol, a hydrochloric acid solution and water.

The purified polymer was finally dried at 180° C. for 48 hours under vacuum (30 mbar).

### Example 2

Example 2 corresponds to an experiment under the same conditions as Example 1, except that benzoyl chloride was added in a molar proportion relative to 1,4-bis(4-phenoxybenzoyl)benzene equal to 0.029 and a temperature ramp at 1° C./min was performed to bring the reaction mixture up to the final polymerization temperature of 90° C.

### Example 3

Example 3 corresponds to an experiment under the same conditions as Example 1, except that a temperature ramp at 1.5° C./min was performed.

### Example 4

Example 4 corresponds to an experiment under the same conditions as Example 2, except that a temperature ramp at 1.5° C./min was performed.

### Example 5

Example 5 corresponds to an experiment under the same conditions as Example 3, except that the 1,4-bis(4-phenoxybenzoyl)benzene/ortho-dichlorobenzene mass proportion is equal to 0.056 and benzoyl chloride was added in a molar proportion relative to the 1,4-bis(4-phenoxybenzoyl)benzene equal to 0.049.

### Example 6

Example 6 corresponds to an experiment under similar conditions to those of Example 1, except that a temperature ramp at 0.75° C./min was performed.

In addition, the reaction solvent was added fractionally in two portions. The first fraction (about 66%) was introduced with the 1,4-bis(4-phenoxybenzoyl)benzene and the acid chlorides and then cooled to −5° C., before proceeding with the introduction of the aluminum trichloride. Once all the aluminum trichloride had been added, the second solvent fraction (about 33%) preheated to 125° C. was added continuously during the temperature ramping.

### Comparative Example 1

Comparative Example 1 corresponds to an experiment under the same conditions as Example 1, except that a temperature ramp at 0.6° C./min was performed.

### Comparative Example 2

Example 2 corresponds to an experiment under the same conditions as Example 1, except that a temperature ramp at 3.0° C./min was performed and the benzoyl chloride was added in a molar proportion relative to the 1,4-bis(4-phenoxybenzoyl)benzene equal to 0.049.

### Comparative Example 3

Comparative Example 3 corresponds to an experiment under the same conditions as Example 3, except that the reaction medium was cooled and maintained at a temperature of 7° C. for the step of placing in contact with aluminum trichloride.

### Comparative Example 4

Two jacketed reactors (R1) and (R2) equipped with stirring systems and a system for inertizing the headspace under a stream of nitrogen were used.

1,4-Bis(4-phenoxybenzoyl)benzene, ortho-dichlorobenzene, terephthaloyl and isophthaloyl chlorides, aluminum trichloride and benzoyl chloride were introduced into the reaction medium in the same proportion as in Example 2 but according to a process corresponding to the prior art procedures consisting in dispersing a cold premix in preheated reaction solvent.

A fraction S=0.31 of ortho-dichlorobenzene (mole fraction of ortho-dichlorobenzene expressed relative to the total amount of ortho-dichlorobenzene used for the polymerization reaction) and 1,4-bis(4-phenoxybenzoyl)benzene were first added with stirring into reactor R1.

Dynamic vacuum distillation and inertizing with nitrogen were performed so as to remove any trace of residual water from the reaction medium.

The mixture of terephthaloyl and isophthaloyl chlorides and the benzoyl chloride were then added with stirring.

The reaction medium in reactor R1 was then cooled to −5° C. Aluminum trichloride was added to the reaction medium with stirring, to form the reaction mixture, the temperature of the reaction mixture being maintained at about −5° C. throughout the addition step.

Once all the aluminum trichloride had been added, the contents of reactor R1 were transferred into reactor R2 with stirring, comprising a fraction 1-S=0.69 of ortho-dichlorobenzene brought to and maintained at a temperature of 85° C. The reaction mixture was then maintained at this temperature for one hour.

The same product mixture purification process as in Example 1 was then performed.

### Comparative Example 5

Comparative Example 5 corresponds to an experiment under the same conditions as Comparative Example 4, except that the benzoyl chloride was added in a molar proportion relative to the 1,4-bis(4-phenoxybenzoyl)benzene equal to 0.035.

### Results

The yield for each process was calculated according to the following formula:

R (%)=100*m_{polymer}/[0.996 m_{EKKE}+0.651(m_{TCl}+m_{ICl})+0.748 m_{BzCl}]
in which:
m_{polymer} is the mass of polymer recovered at the end of the process;
m_{EKKE}, m_{TCl}, m_{ICl} and m_{BzCl} are the respective masses of 1,4-bis(4-phenoxybenzoyl)benzene, terephthaloyl chloride, isophthaloyl chloride and benzoyl chloride introduced into the reaction mixture.

In the various experiments above, the polymer was obtained in the form of porous flakes. They were characterized by viscosity measurement, by evaluation of the amount of benzoyl chain ends, by screening analysis of their particle size distribution, by measurement of their tapped density and by measurement of their specific surface area.

Their inherent viscosity (IV), expressed in dl/g, was measured at a concentration of 0.0005 g/mL in a 96.00% sulfuric acid solution (mass fraction) at 25° C. using a viscometer such as an Ubbelohde suspended-level viscometer (capillary inside diameter of 1.03 mm), according to the standard ISO 307-2009 applied to PEKK.

The molar concentration of benzoyl chain ends (FDC_{BZ}), expressed as micro-equivalents of benzoyl chain ends per gram of polymer, could be determined by the NMR method. Analysis was performed by proton NMR (Avance 400 III HD, Avance 400 NEO). The samples were dissolved at room temperature in dichloromethane-d2, with addition of trifluoroacetic acid-d. All the lines observed between 8.8 ppm and 6.8 ppm correspond to the protons of the polyether ketone ketone units. At 7.58 ppm, a line attributable to the b protons of the benzoyl chain end is revealed. By integrating all the lines in the spectrum and incorporating the line at 7.58 ppm, it is possible to determine the benzoyl chain-end content of the polymer.

The particle size distribution of the flakes, notably the proportion of flakes with a size strictly greater than 450 micrometers (%>450 μm) and the proportion of flakes with a size strictly greater than 630 micrometers (%>630 μm), was evaluated by screening. More specifically, an AS200 digit CA® vibrating sieve shaker sold by the company Retsch was used, with a 200 mm diameter sieve and mesh sizes suitable for the sizes measured (450 μm to measure the proportion of flakes with a size strictly greater than 450 micrometers and 630 μm to measure the proportion of flakes with a size strictly greater than 630 micrometers). The product to be screened was placed on the upper sieve (about 60 g) and the machine was set to have an amplitude of 2 mm in intermittent activated mode (10 s).

The screening time was determined as follows: screening was activated for 5 minutes, on conclusion of which the sieve and the receptacle receiving the particles passing through the sieve were weighed. The whole unit is placed back on the sieve for a further 5 minutes. If the sieve mass remains unchanged, then screening is complete. If this is not the case, screening is repeated until the weighed masses are stable.

The tapped density was measured according to the standard ISO 1068-1975 (F) adapted in the following manner:
The powder is conditioned for 24 hours at 23° C. and 50% RH;
A volume of powder (flakes) is introduced into an accurate graduated 250 ml glass measuring cylinder;
If necessary, the free surface of the powder is leveled off, without tapping it, and the volume V0 is recorded;
The measuring cylinder with the powder is weighed on a balance with an accuracy of 0.1 g, which has been tared beforehand;
The measuring cylinder is placed on the plate of the STAV 2003 tapping machine;
It is tapped by dropping 1250 times, and the volume V1 is recorded;
It is tapped by dropping 1250 times, and the volume V2 is recorded;
The tapping operation is repeated until two equivalent volumes Vi are obtained.
Vf corresponding to the identical volumes Vi is recorded.

The tapped density is the mass of powder introduced divided by Vf. It is expressed in kg/m³.

The Specific Surface Area (SSA) denotes the ratio of the actual surface area of a powder to the amount of material in that powder. It is expressed in m²/g. It is measured by: degassing, adsorption of nitrogen gas onto the powder (flakes), and then determined using the Brunauer-Emmett-Teller (BET) equation according to the standard ISO 9277:2022.

All the results are collated in the tables below:

TABLE 1

| | Temp. | | Other | | | | | | |
|---|---|---|---|---|---|---|---|---|---|
| | ramp | BzCl/EKKE | noteworthy | R | IV | FDC_{Bz} | IV* | % >450 | % >630 |
| # exp. | (° C./min) | mole ratio | condition | (%) | (dl/g) | (μeq/g) | FDC_{Bz} | μm | μm |
| Ex. 1 | 0.8 | 0.042 | | 76 | 0.99 | 51 | 50.5 | 12% | 0% |
| Ex. 2 | 1 | 0.029 | | 82 | 1.09 | 38 | 41.4 | ND | ND |
| Ex. 3 | 1.5 | 0.042 | | 80 | 1.03 | 52 | 53.6 | 16% | 0% |
| Ex. 4 | 1.5 | 0.029 | | 85 | 1.13 | 40 | 45.2 | | |
| Ex. 5 | 1.5 | 0.049 | Reaction | 85 | 0.84 | 59 | 49.6 | 5% | 1% |
| | | | mixture more | | | | | | |
| | | | concentrated | | | | | | |
| | | | in the | | | | | | |
| | | | reaction | | | | | | |
| | | | solvent | | | | | | |
| Ex. 6 | 0.75 | 0.042 | Partial | 75 | 0.93 | 54 | 50.2 | 6% | 4% |
| | | | introduction | | | | | | |
| | | | of the solvent | | | | | | |
| | | | during the | | | | | | |
| | | | placing in | | | | | | |
| | | | contact of the | | | | | | |
| | | | reagents | | | | | | |
| Comp. | 0.6 | 0.042 | | 60 | 0.95 | ND | ND | 23% | 0% |
| 1 | | | | | | | | | |
| Comp. | 3 | 0.049 | | 9 | 0.9 | ND | ND | ND | ND |
| 2 | | | | | | | | | |
| Comp. | 1.5 | 0.042 | Placing in | 42 | 0.96 | ND | ND | 53% | 21% |
| 3 | | | contact with | | | | | | |
| | | | AlCl₃ at 7° C. | | | | | | |
| Comp. | — | 0.029 | Cold premix | 74 | 0.93 | 37 | 34.4 | 89% | >60% |
| 4 | | | introduced | | | | | | |
| | | | into hot | | | | | | |
| | | | solvent | | | | | | |
| Comp. | — | 0.035 | Cold premix | 71 | 0.92 | 40 | 36.8 | 94% | >60% |
| 5 | | | introduced | | | | | | |
| | | | into hot | | | | | | |
| | | | solvent | | | | | | |

“ND” (Not Determined) means that the measurement was not performed.

TABLE 2

| | Tapped density | |
|---|---|---|
| # exp. | (kg/m³) | SSA (m²/g) |
| Ex. 1 | 214 | ND |
| Ex. 2 | 202 | ND |
| Ex. 3 | 234 | ND |
| Ex. 4 | 200 | 2.2 |
| Ex. 5 | 285 | ND |
| Ex. 6 | 218 | 1.8 |
| Comp. 1 | 223 | ND |
| Comp. 2 | 117 | ND |
| Comp. 3 | 199 | ND |
| Comp. 4 | ND | 5.9 |
| Comp. 5 | 180 | ND |

Comparison of Examples 1 to 5 with Comparative Examples 4 and 5 shows that the process according to the invention makes it possible to obtain a polyether ketone ketone with a higher yield (Table 1), compared with the prior art process consisting in preparing a cold premix and dispersing it in preheated solvent. The process notably allows a polymer to be obtained which has a high viscosity and at the same time incorporates a large amount of chain-limiting agent as a chemical chain-end function. The process also allows smaller flake sizes to be obtained.

Comparison of Examples 1 to 5 with Comparative Examples 1 and 2 shows the necessary selection relating to the average heating rate for the gradual heating step. Specifically, poor yields are obtained if the average heating rate is too slow or too fast during the gradual heating step. These poor yields are even lower than those obtained via the prior art process consisting in preparing a cold reaction premix and dispersing it in preheated solvent (see Comparative Examples 4 and 5).

Comparison of Examples 1 and 3 with Comparative Example 3 shows that, in the case where the reagents are placed in contact for a sufficiently long time, the 1,4-bis(4-phenoxybenzoylbenzene) moreover being introduced into the entire reaction solvent, a sufficiently low contact temperature is required to allow the 1,4-bis(4-phenoxybenzoylbenzene) to remain suspended in the reaction mixture for a sufficiently long time, thereby enabling the delayed polymerization reaction to be accelerated and ultimately increasing the yield for the process.

Comparison of Example 5 with Example 3 shows that the process according to the invention may be performed with a higher concentration of chemical compounds in the reaction solvent.

Comparison of Example 4 with Comparative Example 4 shows that, for a benzoyl chain-end molar concentration added to the reaction mixture, the process according to the invention makes it possible to obtain a polymer with a higher viscosity, whereas the prior art process consists in preparing a cold reaction premix and dispersing it in preheated solvent. Moreover, the comparison shows that, for a benzoyl chain-end molar concentration added to the reaction mixture, the process of the invention affords a polymer having a higher chain-end proportion derived from the chain-limiting agent.

Comparison of Example 6 with Example 1 shows that the reaction solvent can be introduced in its entirety during the placing in contact of the reagents, or on the contrary in a portionwise manner, a part of the reaction solvent possibly being advantageously used to perform the gradual heating step.

Comparison of Examples 1 to 6 with Comparative Examples 1 and 2 shows that the higher the temperature ramp, the lower the tapped density of the flakes obtained (Table 2). Moreover, comparison of Examples 1 to 6 with Comparative Examples 3 and 5 shows that the tapped density is higher for the coarse powder according to the invention than for powders obtained by introducing cold premix into hot reaction solvent.

Comparison of Example 4 with Comparative Example 4 shows that the flakes obtained via the process according to the invention have a lower specific surface area (Table 2).

The initial complex viscosity (first measurement point after sample insertion and oven temperature stabilization after 5 minutes), at 380° C., 1 Hz, under nitrogen, was measured for:
a polyether ketone ketone manufactured according to US 2012/0263953 using benzoic acid as the dispersant, with a T/I ratio of 70/30, an inherent viscosity of 1.13 dl/g, and a residual benzoic acid mass proportion of 0.6% by weight relative to the polymer weight (gas chromatography),
the polyether ketone ketone according to Example 4 also having an inherent viscosity of 1.13 dl/g.

The polyether ketone ketone manufactured via a process using benzoic acid as dispersant has an initial complex viscosity of 5380 Pa·s.

The polyether ketone ketone according to Example 4 has an initial complex viscosity of 1320 Pa·s.

This shows that the use of a dispersant in the process for manufacturing the polyether ketone ketone and/or its residual presence in the polyether ketone ketone thus manufactured has adverse consequences on the thermal stability of the polymer.

Specifically, this shows a rapid increase in viscosity when the polymer is melted.

1. A process for manufacturing a polyether ketone ketone, involving:
placing an aromatic ether or a mixture of aromatic ethers, comprising at least 50 mol % of 1,3-bis(4-phenoxybenzoyl)benzene, 1,4-bis(4-phenoxybenzoyl)benzene or a mixture thereof, relative to the total number of moles of aromatic ether(s), in contact with an acyl chloride or a mixture of acyl chlorides, and a Lewis acid, in all or part of a reaction solvent, so as to form a reaction mixture.
the 1,3-bis(4-phenoxybenzoyl)benzene and/or 1,4-bis(4-phenoxybenzoyl)benzene essentially not being dissolved in the reaction solvent at the end of the step of placing in contact; and,
polymerizing the reaction mixture, the polymerization being performed, at least in part, at a temperature Tₚ greater than or equal to 50° C.;
the process being characterized in that it comprises a step of gradual heating of the reaction mixture until acceleration of the polymerization reaction is achieved,
the gradual heating step being performed at an average heating rate chosen in a range from 0.65° C./minute to 2.5° C./minute;
one or more chain-limiting agents being optionally added during the process.

2. The process as claimed in claim 1, in which the acyl chloride(s) are chosen from the group consisting of: terephthaloyl chloride, isophthaloyl chloride, phthaloyl chloride, phosgene, adipoyl dichloride, tetrabromophthaloyl chloride, and compounds having the chemical formula: 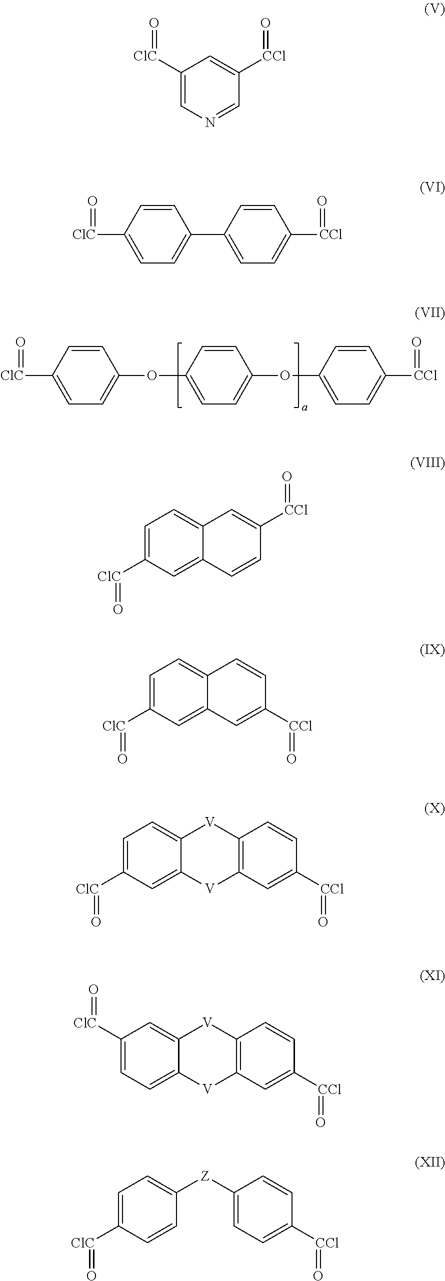
in which:
a is an integer ranging from 0 to 3;
V is chosen from: —O—, —S—, —(CF₂)_{q}—, —(CH₂)_{q}—, or —C((CH₃)₂)—;
Z is chosen from: —C(O)—, —SO₂—, —C(O)—C₆H₄—C(O)—, —O—(CF₂)_{q}—O—, —S—, —(CF₂)_{q}—, —(CH₂)_{q}—, or C—(CH₃)₂—;
and in which q is an integer ranging from 1 to 20.

3. The process as claimed in claim 1, in which a mixture of aromatic ethers is used comprising, in addition to an aromatic ether chosen from the group consisting of: 1,3-bis(4-phenoxybenzoyl)benzene, 1,4-bis(4-phenoxybenzoyl)benzene, or a mixture thereof, at least one other aromatic ether chosen from the group consisting of:
diphenyl ether, 4,4′-diphenoxybenzophenone, 3,3′-diphenoxybenzophenone, 3,4′-diphenoxybenzophenone,
the products of reaction by electrophilic Friedel-Crafts substitution of two molecules chosen from: diphenyl ether, 4,4′-diphenoxybenzophenone, 3,3′-diphenoxybenzophenone, 3,4′-diphenoxybenzophenone with an acyl chloride molecule chosen from: phthaloyl chloride, phosgene, adipoyl dichloride, and the compounds having the chemical formula: 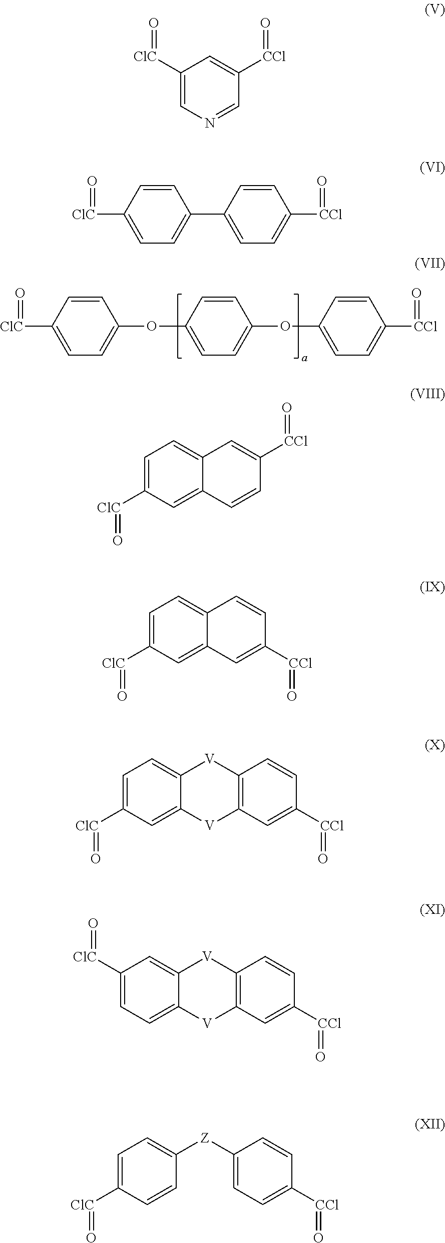
in which:
a is an integer ranging from 0 to 3;
V is chosen from: —O—, —S—, —(CF₂)_{q}—, —(CH₂)_{q}—, or —C((CH₃)₂)—;
Z is chosen from: —C(O)—, —SO₂—, —C(O)—C₆H₄—C(O)—, —O—(CF₂)_{q}—O—, —S—, —(CF₂)_{q}—, —(CH₂)_{q}—, or C—(CH₃)₂—;
and in which q is an integer ranging from 1 to 20;
and the products of the electrophilic Friedel-Crafts substitution reaction of two molecules chosen from: 4,4′-diphenoxybenzophenone, 3,3′-diphenoxybenzophenone, and 3,4′-diphenoxybenzophenone with an acyl chloride molecule chosen from: terephthaloyl chloride and isophthaloyl chloride.

4. The process as claimed in claim 1, in which the reaction solvent is chosen from the group consisting of: ortho-dichlorobenzene, 1,2,4-trichlorobenzene, 1,2,3-trichlorobenzene, ortho-difluorobenzene, and mixtures thereof.

5. The process as claimed in claim 1, in which the Lewis acid is chosen from the group consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof.

6. The process as claimed in claim 1, in which at least one chain-limiting agent is added during the process,
the chain-limiting agent being a nucleophilic chain-limiting agent chosen from compounds having the following chemical formula: 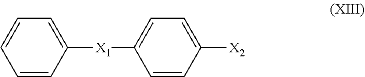
in which:
X₁ represents a covalent bond, —O— or —S—; and
X₂ represents C₆H₅CO or C₆H₅SO₂; and 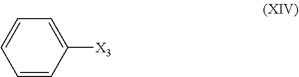
in which:
X₃ represents a halogen atom, an alkyl group or an alkoxy group containing from 1 to 10 carbon atoms;
or the chain-limiting agent being an electrophilic chain-limiting agent chosen from the compounds having the following formula: 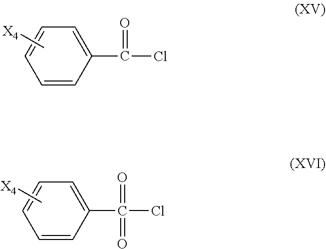
in which:
X₄ represents: a hydrogen atom, a halogen atom, an alkyl or alkoxy group containing from 1 to 10 carbon atoms, a nitro, C₆H₅CO or C₆H₅SO₂ group;
or having the following formula: 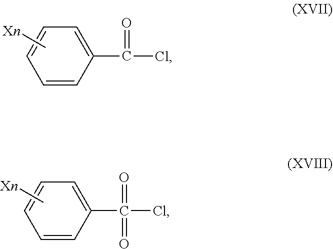
in which:
Xn represents n groups, n being an integer chosen between 2 and 5, each group being independently chosen from: a halogen atom, an alkyl or alkoxy group containing from 1 to 10 carbon atoms, or a nitro, C₆H₅CO or C₆H₅SO₂ group.

7. The process as claimed in claim 1, in which the mole ratio of aromatic ether(s) relative to the reaction solvent(s) that have been introduced in total into the reaction mixture at the end of the polymerization is: from 0.005 to 0.030.

8. The process as claimed in claim 1, in which an excess of aromatic ether(s) is reacted with the acyl chloride(s), the mole ratio of aromatic ether(s) relative to the acyl chloride(s) that have been introduced in total into the reaction mixture at the end of the step of placing in contact being: from 1.001 to 1.1.

9. The process as claimed in claim 1, in which the mole ratio of Lewis acid(s) relative to the aromatic ether(s) that have been introduced in total into the reaction mixture at the end of the step of placing in contact is: from 5.0 to 7.0.

10. The process as claimed in claim 1, in which the reaction mixture is maintained during the step of placing in contact at a temperature T₀ of less than or equal to 5° C.

11. The process as claimed in claim 1, in which the temperature Tₚ is less than or equal to 120° C.

12. The process as claimed in claim 1, in which the gradual heating step and the polymerization are performed with stirring.

13. The process as claimed in claim 1, in which a mixture of aromatic ethers is used, the mixture of aromatic ethers consisting of an aromatic ether chosen from: 1,4-bis(4-phenoxybenzoyl)benzene, 1,3-bis(4-phenoxybenzoyl)benzene or a mixture of 1,4-bis(4-phenoxybenzoyl)benzene and 1,3-bis(4-phenoxybenzoyl)benzene; and,
another aromatic ether chosen from: diphenyl ether, 4,4′-diphenoxybenzophenone, or a mixture of diphenyl ether and 4,4′-diphenoxybenzophenone;
the mixture of aromatic ethers comprising up to 20 mol %, relative to the total number of moles of aromatic ethers.

14. The process as claimed in claim 1, in which the aromatic ether or, where appropriate, the mixture of aromatic ethers, consists of or, respectively, consists essentially of 1,4-bis(4-phenoxybenzoyl)benzene.

15. The process as claimed in claim 1, in which the acyl chloride is chosen from the group consisting of isophthaloyl chloride, terephthaloyl chloride, and a mixture thereof

16. The process as claimed in claim 1, in which the Lewis acid is aluminum trichloride.

17. The process as claimed in claim 1, in which the reaction solvent is ortho-dichlorobenzene.

18. The process as claimed in claim 1, in which a chain-limiting agent is added during the process,
the chain-limiting agent being benzoyl chloride, p-fluorobenzoyl chloride, 3,5-difluorobenzoyl chloride, or a mixture thereof.

19. The process as claimed in claim 1, in which the gradual heating step is performed at an average heating rate ranging from 0.70° C./min to 2.2° C./min.

20. The process as claimed in claim 1, in which a mass fraction of reaction solvent at least equal to 0.15 is introduced before the end of the step of placing in contact, the mass fraction being calculated by dividing the weight of reaction solvent which has been introduced at the end of the step of placing in contact by the total weight of reaction solvent which has been introduced at the end of the polymerization.

21. The process as claimed in claim 1, in which
the polyether ketone ketone manufactured consists of repeating units of formula (I) and of formula (II), the proportion of units of formula (II) relative to the units of formula (I) being from 55:45 to 95:5,
the unit of formula (I) having the chemical formula: 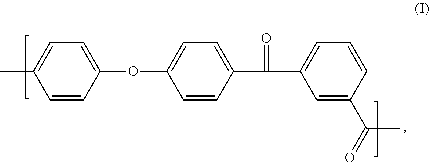
and the unit of formula (II) having the chemical formula:

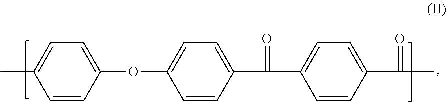

22. A polyether ketone ketone having chain ends controlled by a chain limiter, satisfying the following inequality:
IV*FDC_{(LDC)}≥LIM; (eq. 1)
in which:
IV represents the inherent viscosity of the polymer, expressed in dl/g, as measured according to the standard ISO 307-2009 applied to PEKK;
FDC_{(LDC)} represents the molar concentration of the group originating from the chain limiter relative to the total weight of the polymer, expressed in micro-equivalents of chain limiter per gram of polymer;
LIM is a number at least equal to 40.

23. The polyether ketone ketone as claimed in claim 22, in which the chain-limiting agent is a nucleophilic chain-limiting agent chosen from the compounds having the following chemical formula: 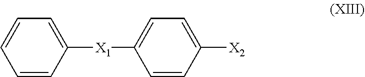
in which:
X₁ represents a covalent bond, —O— or —S—; and
X₂ represents C₆H₅CO or C₆H₅SO₂; and 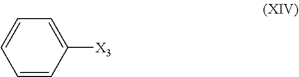
in which:
X₃ represents a halogen atom, an alkyl group or an alkoxy group containing from 1 to 10 carbon atoms;
or, the chain-limiting agent is an electrophilic chain-limiting agent chosen from the compounds having the following formula: 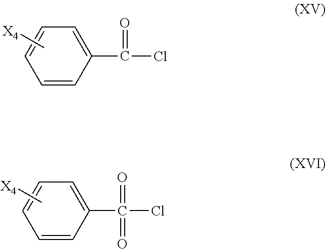
in which:
X₄ represents: a hydrogen atom, a halogen atom, an alkyl or alkoxy group containing from 1 to 10 carbon atoms, or a nitro, C₆H₅CO or C₆H₅SO₂ group;
or having the following formula: 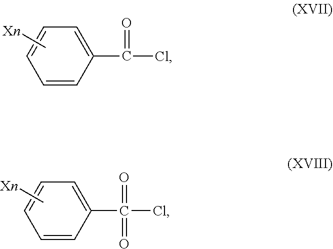
in which:
Xn represents n groups, n being an integer chosen between 2 and 5, each group being independently chosen from: a halogen atom, an alkyl or alkoxy group containing from 1 to 10 carbon atoms, or a nitro, C₆H₅CO or C₆H₅SO₂ group.

24. The polyether ketone ketone as claimed in claim 22, in which the chain-limiting agent is benzoyl chloride, p-fluorobenzoyl chloride, 3,5-difluorobenzoyl chloride, or a mixture thereof.

25. The polyether ketone ketone as claimed in claim 22, having an inherent viscosity of greater than or equal to 0.4 dl/g; and/or
having an inherent viscosity of less than or equal to 2 dl/g;
the inherent viscosity being measured at a concentration of 0.0005 g/mL in a 96.00% sulfuric acid solution at 25° C. using a viscometer such as an Ubbelohde suspended-level viscometer according to the standard ISO 307-2009.

26. The polyether ketone ketone as claimed in claim 25, having an inherent viscosity ranging from 0.98 dl/g, to 1.4 dl/g.

27. The polyether ketone ketone as claimed in claim 22, consisting of repeating units of formula (I) and of formula (II), the proportion of units of formula (II) relative to the units of formula (I) being from 55:45 to 95:5,
the unit of formula (I) having the chemical formula: 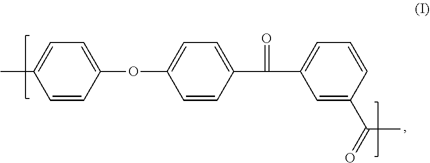
and the unit of formula (II) having the chemical formula:

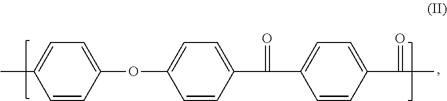

28. The polyether ketone ketone as claimed in claim 22, not comprising any dispersant.

29. The polyether ketone ketone powder as claimed in claim 22, for which the mass proportion of particles with a size strictly greater than 630 micrometers is less than or equal to 25%, as obtained by screening using a sieve with a mesh size equal to 630 micrometers.

30. The polyether ketone ketone powder as claimed in claim 22, for which the mass proportion of particles with a size strictly greater than 450 micrometers is less than or equal to 75%, as obtained by screening using a sieve with a mesh size equal to 450 micrometers.

31. The polyether ketone ketone powder as claimed in claim 22, for which the tapped density, as measured in the examples, is greater than or equal to 200 kg/m³.

32. The polyether ketone ketone powder as claimed in claim 22, for which the BET specific surface area is less than or equal to 4 m/g.
